(19) United States
(12) Patent Application Publication
(10) Pub. No.: US 2019/0224575 A1
(43) Pub. Date: Jul. 25, 2019

(54) METHOD AND SYSTEM FOR EXECUTING AND MANAGING EVENT-BASED GAMES ON A MOBILE DEVICE

(71) Applicant: 9203-4776 QUEBEC INC. (DJEANIUS DIVERTISSEMENT), Joliette (CA)

(72) Inventors: Martine Jean, Joliette (CA); Claude Bouchard, Lanoraie (CA); Patrick Jean, Crabtree (CA)

(21) Appl. No.: 16/258,008

(22) Filed: Jan. 25, 2019

Related U.S. Application Data
(63) Continuation of application No. PCT/CA2017/050898, filed on Jul. 25, 2017.

(30) Foreign Application Priority Data
Jul. 25, 2016 (CA) 2937062

(51) Int. Cl. A63F 13/822; A63F 13/63; A63F 13/47; A63F 13/31

(52) U.S. Cl. CPC A63F 13/822; A63F 13/31; A63F 13/47; A63F 13/63

(57) ABSTRACT

A method and system to setup and to manage one or more role-playing game at a single physical location using mobile device is disclosed. The game is distributed and animated on multiple devices connected in real time to a network, preferably to the Internet. Although participants are gathered at the same time and location, each one uses a personal mobile device programmed to provide to the participant instructions and commands relating to the game. To provide instructions, the system comprises a game server configured to provide the game intelligence. The system further comprises mobile devices of each participant connected to the game server during the game play.

### CROSS-REFERENCE TO RELATED APPLICATIONS

The present patent application claims the benefits of priority of Canadian Patent Application No. 2,937,062, entitled “METHODE ET SYSTEM POUR LES JEUX THEMATIQUES OU DE ROLE SUR UN APPAREIL MOBILE” and filed at the Canadian Intellectual Property Office on Jul. 25, 2016, the content of which is incorporated herein by reference.

### FIELD OF THE INVENTION

The present invention generally relates to systems and methods to manage role-playing games. More specifically, the present invention relates to systems and methods for managing role-playing games where participants are at the same physical location and the participants are executing game instructions on their mobile device to create atmosphere and interactions between said participants.

### BACKGROUND OF THE INVENTION

Thematic board or event games are well known and used in the art, such as “Murder Party/Meurtre et Mystere”. Thematic games generally comprise an enigmatic scene where one or more participants are guilty of a fictitious crime: meanwhile other participants seek to identify the guilty party(ies) of the said fictitious crime through clues and intrigues unveiled during the game.

Other thematic game boards following the same concept are also known in the art, such as, “oratory art” games or domination games where a winner is determined by scoring and/or elimination. Such games create fictitious situations in which a participant must use political strategies to acquire votes of sympathy at the expense of other players in order to acquire the best score or avoid the elimination from the game.

Themes games, as defined in the context of this invention, use the concept of creating fictitious scenes in which participants are gathered in the same physical place and are placed in different situations, such as investigation resolution or confrontation where they must strategically persuade other players to give them vote of confidence to win the game. Players must demonstrate intelligence and skill. Thematic games are typically animated by the game master who animates and uncovers the key elements throughout the game.

Such games require that one person of the group be named as the game leader. The game leader must not be part of the games as a participant as the leader is aware of the conclusions or ending of the game. The leader typically setups the game and ensure that roles are distributed to the participants.

Another drawback occurs when a participant, for any reason, is required to leave the game. In some scenarios, the game may be aborted or cancelled as the role of the participant was crucial to the ending of the game.

There is thus a need for a system and method to manage a thematic game using mobile device aiming at encompassing the drawback of the prior art thematic games.

### SUMMARY OF THE INVENTION

The aforesaid and other objectives of the present invention are realized by generally providing a system and method to manage a thematic game using method devices.

The present invention aims at managing one or more role-playing game using mobile devices such as cell phones, smart tablets, pocket computers and other similar portable devices to play the game. The game is thus distributed and animated on multiple devices connected in real time to a network, preferably to the Internet. Although participants are gathered at the same time and location, each one uses a personal mobile device programmed to provide to the participant instructions and commands relating to the game. To provide instructions, the system comprises a game server configured to provide the game intelligence. The system further comprises mobile devices of each participant connected to the game server during the game play.

Two methods for a participant to connect to the game server and to access interactive instructions distributed in real time are provided. The first method comprises installing a computer program on the mobile device providing a game framework. Such game framework is configured to download instructions, images and information from the server according to the progress of the game or of a participant in the game. The second method comprises opening a web session on the game server with the mobile device's web browser.

A method to setup a new game is provided. Such method is typically executed by the game organizer. The method generally comprises an organizer connecting to the registration page of a game using a web browser or the computer program on the mobile device. The method may further comprise selecting the desired game to be played, determining the date, time, location and duration of the game to be played and determining the desired maximum number of players and the language of the instructions sent to the group of players. The method further comprises the computer program or application generating and sending an invitation comprising related information to be shared with a selected group and/o to be publicly posted to registered members on the game server.

The method may further comprise selecting a payment method for a participant to play the game. For instance, the payment method may comprise the organizer paying for all participants or each participant paying for them during the registration process for the game to be played. To be registered in the game, a participant must have paid the registration fee prior to the game play when the organizer has not paid for all the participants.

Once the participants being registered, the method may further comprise manually attributing the roles to each participant or the game server automatically attributing a role to each participant, preferably based on preference or characteristics of each participant. The method further comprises sending a communication, such as an e-mail, to each participant confirming the attribution of a role to the participant. The said communication typically comprises a link to a game page, instructions about the attributed role and any other details pertinent for a participant. The method may further comprise sending communication to each participant as reminders of the event or game.

When participants are gathered at the predetermined time and place, each participant connects to the game server via the game application or a web browser. The method may further comprise manually triggering the start or launch of the game using a privileged access. In other embodiments, the start of the game may be triggered automatically by the game server.

A method for playing a thematic game is further provided. The method comprises the game server executing a computer program comprising instructions to execute the game. The method may further comprise the game server transmitting information and instructions to each mobile device of the participants. Typically, such information is displayed via an interface on the participant device (i.e. web interface, user interface of the application). The method further comprises the game server communicating public information to each mobile device of all participant and communicating privileged or private information and instructions to mobile device of concerned players only.

As an example of communicated information, the game application or servers informs the players of the one or more goals to reach to either win the game or score points. Each player plays a fictitious role enacted by the game server. A player must respect the received instructions and carry them out to allow the game to progress.

The method for playing a thematic game may further comprise executing the game by the game server executing sequential and timed scripts to generate events. Preferably, the rate of the said events may be altered during the game. The alteration may be triggered by the interactions of the participants with the game interface. The method may further comprise manually speeding up or slowing down the game, such as the organizer manually speeding or slowing the game via a privileged access. The method further comprises communicating instructions the mobile device of one or more participant to interrogate other participants, such as asking specific questions, to reveal information helping to deduce the strategies of the other participants, contradictory information or simply to compromise one or more participants in order to take a position or influence the votes.

The method further comprises cumulating the answers, votes and feedbacks from the mobile devices of the participants and calculating the score of each participant in real-time. The method may further comprise ending the game when the whole game script or scenario is completed or when the players or organizer end it. Once ended, the game server invites the players to evaluate the organizer, the level of player satisfaction and sends to the players the name of the winner(s), their cumulative score and ranking.

In one aspect of the invention, a computer-implemented method for executing a event-based game on a computer in real-time communication with mobile devices of participants is provided. The participants are physically present at the same location and each mobile device is configured to receive instructions from the computer. The method comprises the computer executing the game events by communicating the participant-specific instructions to the mobile device associated to the participant, the participant executing the received instructions. and using an evaluation method of the participants to determine the one or more winners of the game based on feedback received from the mobile device.

The method further comprises the participant inputting feedback based on the execution of the received instructions, the mobile device communicating the feedback to the computer and the evaluation method using the feedback received from the mobile devices to determine the one or more winners of the game.

The evaluation method may be at least one of the followings voting for or against another participant, answering questions relating to a theme of the game, executing an action for or against another participant through the mobile device or performing a skill test on the mobile device. The instructions received by the mobile device may be one of the followings: questions to the participant, questions with a single or multiple selection of one or more words, letters, numbers, images or sounds, requesting to draw on the mobile device, requesting to move the mobile device, requesting taking a picture, an image or a movement with a camera of the mobile device, requesting to touch or to select static or moving image on the mobile device, exchanging virtual goods with other participants, exchanging virtual goods with the computer or using virtual tools on the mobile device.

The method may further comprises communicating one or more questions to the mobile device of a participant, the mobile device of the participant communicating answer provided by the participant and processing the one or more answers communicated by the mobile device. The processing of the one or more answers may comprise calculating the coherence level of the answers of the participant, compiling the number of the correct and incorrect answers, compiling and comparing the number of votes for participants, compiling the number of trades between participants, compiling and comparing the value of trades between participants, compiling number of success or failed to accomplish the instructions communicated by the computer and evaluated by the participants, compiling number of success or failed instructions accomplished in a participants challenge evaluated by the participants, compiling and comparing ranking of the computer instructions evaluated by the participants, compiling and comparing ranking of a participants challenge evaluated by the participants, measuring time reaction between participants, measuring the time between a question is communicated and the related answer is received by the computer, measuring time and the precision of a single or sequential execution with the mobile device or measuring precision of a movement or an execution with the mobile device. The processing of the one or more answers may further comprise calculating the coherence of the provided answer or measuring the time between the question is communicated and the answer is received.

The method may further comprise communicating to at least one of the mobile devices of the participants information being unrelated to the game events or increasing or decreasing the pace of at which the instructions are communicated to the mobile device. The method may further comprise reducing the accepted response time to provide the answer.

The computer-implement method may further comprise automatically selecting a scenario for a thematic game or automatically selecting a scenario for the thematic game based on the participants. The automatic selection of a scenario for the thematic game may further comprise calculating adherence level of each participant, selecting participants having a predetermined calculated adherence level, selecting scenarios not played by the selected participants from a list of available scenarios, calculating a compatibility rate for each scenario based on the list of selected participants or selecting the scenario having the optimal compatibility rate. The calculating of the adherence level of each participant may be based on at least information store in a profile of the participant, information fetched from third parties data sources or history of satisfaction scoring provided for past games. The selection of the scenario may further be based on at least preferred authors of the game less similarity of game played by the participant or preferred types role and games less similarity of game played by the participant. The automatic selection of a scenario for the thematic game may further comprise selecting a predetermined number of less played scenarios if none not played scenario is selected.

The computer-implement method may further comprise adding side stories or challenges to the game during game play. Adding side stories or challenges to the game may further comprise calculating a predictability index of each participant and an index of participation, selecting side stories from a list of side stories or challenges not experimented by the participants, matching selected side stories or challenges to the participants based on preferences of the participants and assigning selected side stories or challenges to the participants having the highest calculated predictability index or the challenges of the game. The side stories or challenges may be assigned only to participants requesting a less predictable game. The calculation of a predictability index of each participant may use one of receptivity data, time reaction to solve clues or skills or the calculation of the index of participation may be based on percentage of answers of participants.

The computer implemented method may further comprise substituting one of the participants during game play. The substitution of the participant may be temporarily and the substituted participant may be a virtual participant controlled by a computer. The method may further comprise using a mobile device to communicate to one or more participants a predetermined question from the virtual player and the computer generating answer based on a received predetermined question to the virtual player, generating diversions to participants according to the participants scoring or position in the game or using a random function when generating answer. The substitution of a participant may further comprise generating an invitation and a unique identifier associated with an invitation, communicating the unique identifier to a desired substitute participant, the desired substitute participant confirming registration by inputting the unique identifier in the computerized device, upon reception of the confirmation, adding the substitute participant to the list of participants.

The substitution of a registered participant may also comprise an available participant activating availability for a spontaneous game on a computerized device, the computerized device communicating to a game server the coordinates of the computerized device, displaying the available participants located within a predetermined radius of the physical location and selecting an available participant to be invited to the game.

In another aspect, the game may be a thematic game, the computer implemented method further comprising assigning a character to each participant and displaying the character information about the character assigned the mobile device associated with the character.

The thematic game may be an investigation game. In such embodiment, the method may further comprise providing a triggering event and an investigation in the scenario, assigning at least one character responsible for the triggered event, calculating or evaluating the performance of the participants through evaluation means and requesting the participants to vote for the one or more characters responsible for the trigging event using the mobile devices. The method may further comprise sending instructions to the mobile device of one or more participants, the instructions aiming at distracting or dissimulating elements based on the evaluation means or displaying the responsible of the triggering event on the mobile device of all the participants. In some embodiments, the triggering event is a crime.

The thematic game may a survival or power rising thematic game. In such embodiments, the method further comprises the participants using the mobile devices to exchange information and titles or create and reverting alliances, voting for or against other participants, removing or decreasing score of one or more participants having a number of votes under a predetermined value or removing or decreasing score of one or more participants having a number of favorable trades under a predetermined value.

In yet another aspect of the invention, a computer implemented method for managing an event-base game at a physical location using computerized devices of participants is disclosed. The method comprises creating an event-based game, inviting participants, the invited participants registering for the event-based game using a computerized device, confirming registration of the registered participants, communicating the game rules to each mobile device of the participants prior to the beginning of the game and closing the registration to the event-based game. An organizing user may manage the event-based game and may be a participant to the game.

The method may further comprise assigning a character to each registered participant and communicating the assigned character to each mobile device of the participants prior to the beginning of the game. The assignment of a character to each participant may further comprise fetching preferences of each participant, calculating a matching index for each available character based on characteristics of the available character and the fetched preferences of each participant and assigning to the participant the character having the highest matching index.

The method for managing the game may further comprise substituting a registered player prior to the beginning of the game. The substitution of a registered player may further comprise generating an invitation and a unique identifier associated with an invitation, communicating the unique identifier to a desired substitute participant, the desired substitute participant confirming registration by inputting the unique identifier in the computerized device and upon reception of the confirmation, adding the substitute participant to the list of participants. The substitution of a registered player may further comprise an available participant activating availability for a spontaneous game on a computerized device, the computerized device communicating to a game server the coordinates of the computerized device, displaying the available participants located within a predetermined radius of the physical location or selecting an available participant to be invited to the thematic game.

The event-based game may private or public or may be spontaneous. In such case, the method may further comprise an available participant activating availability for a spontaneous game on a computerized device, the computerized device communicating to a game server the coordinates of the computerized device, displaying the available participants located within a predetermined radius of the physical location, selecting one or more available participants to be invited to the thematic game and communicating the invitation to the selected available participants.

In yet other embodiment, the method may further comprise an available participant activating availability for a spontaneous game on a computerized device, the computerized device communicating to a game server the coordinates of the computerized device, displaying the spontaneous event on the mobile device of the available participant, and the available participant registering to the spontaneous events.

In another aspect of the invention, a system for managing a event-based game at a physical location for a plurality of participants is provided. Each participant has a computerized device. The system comprises a computer network, a server comprising a processing unit, a computer program executing a game server on the processing unit, a storage unit adapted to store participant profiles and game scenarios, a network adapter configured to connect to the computer network. The server is configured to execute the game events by communicating the participant-specific instructions to the mobile device associated to the participant, execute an evaluation method of the participants to determine the one or more winners of the game based on feedback received from the mobile device.

Each computerized device is configured to provide feedback to the server, the computerized device comprising a processing unit configured to execute a computer program, a display unit adapted to display game user interfaces, the user interfaces comprising a mean display the received instructions, a computer program executing a game engine, the computer program being configured to communicate feedback to the server and a network adapter configured to connect to the computer network.

The server is further configured to process and to communicate to other computerized devices of the participants one or more instructions based on the communication received from the computerized device of a participant.

The computerized device may further comprise a mean for the participant to input feedback based on the execution of the received instructions, the computerized device being configured to communicate the feedback to the server, the evaluation method further using the feedback received from the mobile devices to determine the one or more winners of the game. The computerized devices may be further configured for a participant to execute voting for or against another participant, answering questions relating to a theme of the game, executing an action for or against another participant or performing a performance skill test.

The server may be further configured to process of the one or more answers received from the mobile device, the processing comprising calculating the coherence of the provided answer and measuring the time between the question is communicated and the answer is received. The server may be further configured to communicate to at least one of the computerized devices information being unrelated to the game or to increase or decrease the pace of at which the instructions are communicated to the mobile device.

The data source of the server may be further configured to store side stories and the server being further configured to add one or more side stories to the scenario of the game during game play. Adding side stories to the scenario during game play may further comprise calculating a predictability index of each participant using receptivity data and an index of participation, selecting side stories from a list of side stories not played by the participants, match selected side stories to the participants based on preferences of the participants, assigning selected side stories to the participants having the highest calculated predictability index.

The game may be a thematic game comprising different characters. The server may further be configured to assign one of the different characters to each participant and the user interfaces further comprising a mean to display the assigned character information to the participant. The thematic game may be an investigation game and the server may further be configured to assign a character responsible for a triggering event of the investigation game. In some embodiments the triggering event is a crime.

The thematic game may be a survival or power rising thematic game. In such embodiments, the user interfaces further comprises means to exchange information and titles with other participants or create and reverting alliances with one or more other participants, means for voting for or against other participants or means for removing one or more participants having no vote.

66) The computerized devices may be mobile devices and the computer program executing the game engine may a mobile application. The computer network may be Internet.

The computerized device may further be configured to reveal clues or information by transforming an object or a person in a photo taken by a camera of the computerized device, the transformation being displayed on the display unit of the computerized device.

The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1 is an illustration of a system for playing thematic or role-playing game on mobile devices in accordance with the principles of the present invention.

FIGS. 2A to 2C are workflow diagrams of a method to setup a new thematic game in accordance with the principles of the present invention.

FIG. 3 is a workflow diagram of a method to find participants to a thematic game to be played within few hours in accordance with the principles of the present invention.

FIG. 4 is a workflow diagram of a method to substitute a participant prior to the beginning of a thematic game where role have been attributed in accordance with the principles of the present invention.

FIGS. 5A to 5C are workflow diagrams of a method to execute an investigation thematic game in accordance with the principles of the present invention.

FIGS. 6 and 7 are workflow diagrams of a method to execute a power gain or ascension thematic game in accordance with the principles of the present invention.

FIG. 8 is a workflow diagram of a method to select the game scenarios of a thematic game in accordance with the principles of the present invention.

FIG. 9 is a workflow diagram of a method to add side stories to a main scenario of a thematic game in real-time in accordance with the principles of the present invention.

FIG. 10 is an exemplary sequence diagram of communications between the mobile devices and the game server in accordance with the principles of the present invention.

FIG. 11 is an example of an interface of a computer program running on a mobile device for the registration of a participant to a thematic game.

FIG. 12 is an exemplary user interface configured to display the profile of a participant.

FIG. 13 is an exemplary user interface configured to display the public profile of a participant.

FIG. 14 is an exemplary user interface configured to login to the game server.

FIG. 15 is an exemplary user interface configured to display information and links to different events and to features of the application.

FIG. 16 is an exemplary user interface configured to display search menu for all public events hosted on one or more game servers.

FIG. 17 is an exemplary user interface configured to display invitation to a public or non-public game event.

FIG. 18 is an exemplary user interface configured to display payment information to register to an event.

FIG. 19 is an exemplary user interface of a message box.

FIG. 20 is an exemplary user interface configured to find potential participants located within a predetermined radius of distance.

FIG. 21 is an exemplary user interface to select a thematic game to be played on the one or more game server.

FIG. 22 is an exemplary user interface presenting detailed information regarding a game scenario or theme.

FIG. 23 is an exemplary user interface to setup a new game.

FIG. 24 is an exemplary user interface of a payment page for all players of a game to be setup.

FIG. 25 is an exemplary user interface presenting the status of invitation of participants to a game to be played.

FIG. 26 is an exemplary user interface to setup a thematic to be played within the next 48 hours.

FIG. 27 is an exemplary user interface for editing details of the invitations to a game to be played.

FIG. 28 is an exemplary user interface of an invitations sent to an invited participant for a spontaneous event.

FIG. 29 is an exemplary user interface displaying information on a selected theme or scenario of a thematic game.

FIG. 30 is an exemplary user interface displaying information and/or details of a registered participant to an event.

FIG. 31 is an exemplary user interface displaying a scoreboard of users/participants to all game held on the game server.

FIG. 32 is an exemplary user interface for assigning roles to participants of a thematic game to be played.

FIG. 33 is an exemplary user interface displaying detailed information about a role or game character.

FIG. 34 is an exemplary user interface for assigning a participant to a role.

FIG. 35 is an exemplary user interface for purchasing a membership on the game server.

FIG. 36 is an exemplary user interface displaying information to a participant about the character assigned to the said participant.

FIG. 37 is an exemplary user interface displaying information about a character assigned to a participant during game play.

FIG. 38 is an exemplary user interface displaying details of the event prior to starting the game.

FIG. 39 is an exemplary user interface displaying details about an event during game play.

FIG. 40 is an exemplary user interface displaying registered participant list prior to assignment of role to each participant.

FIG. 41 is an exemplary user interface displaying registered participant list after assignment of role to each participant.

FIG. 42 is an exemplary user interface displaying details about the participant and the role assigned to the said participant.

FIG. 43 is an exemplary user interface displaying options and game rules for the player prior to role assignment.

FIG. 44 is an exemplary user interface displaying options and game rules during game play.

FIG. 45 is an exemplary user interface displaying menu options for a privileged user (i.e. organizer).

FIG. 46 is an exemplary user interface for an organizer to leave organization of an event.

FIG. 47 is an exemplary user interface for assigning a role to one of the participants matching the role characteristics.

FIG. 48 is an exemplary user interface for voting for a participant during game play.

FIG. 49 is an exemplary user interface for rating organization of a game and the game itself.

FIG. 50 is an exemplary user interface for inputting preferences of a participant.

### DETAILED DESCRIPTION OF THE PREFERRED EMBODIMENT

A novel system and method for playing thematic games on mobile devices will be described hereinafter. Although the invention is described in terms of specific illustrative embodiment(s), it is to be understood that the embodiment(s) described herein are by way of example only and that the scope of the invention is not intended to be limited thereby.

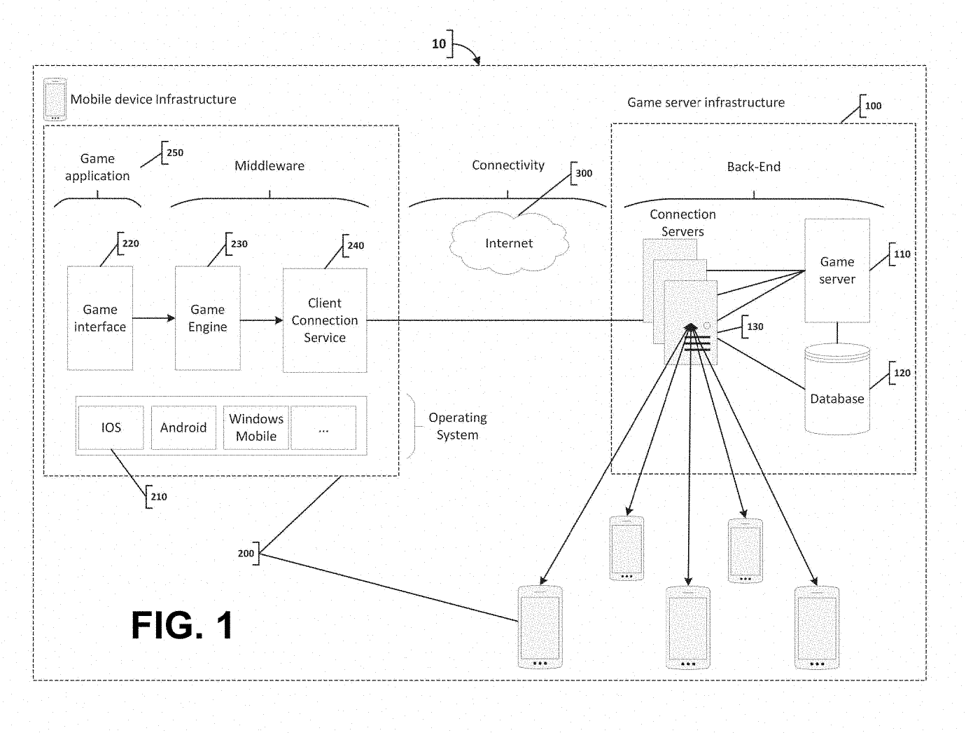

Referring first to FIG. 1, a preferred embodiment of a system to play thematic game 10 is illustrated. The system 10 comprises a server computer 100 and mobile devices 200 connected through a data network 300, such as but not limited to a WAN network, the Internet, a LAN network or any other type of network. The server 100 comprises a computer program acting as a server to manage games. The server program 110 is configured to run a program that carries out the scripts of the current game(s). The server computer 100 further comprises a data source 120 adapted to store data about the games, the participants, the roles and any other relevant information. In a preferred embodiment, the server computer 100 may further execute a program for managing authentication and connections 130 of the mobile devices 200 to the server 110.

The mobile device 200 is typically embodied as a smart phone, a tablet, a smart watch, a portable computer or any other portable device comprising a processor, a display unit and a memory. The mobile device 200 typically comprises a software program 240 configured to communicate with the game server 100. The mobile device 200 generally comprise a central processing unit adapted to execute an operating system 210, such as but not limited to iOS™, Android™ or Windows™. The mobile device 200 further comprises a computer program acting as the game engine 230 and a display unit adapted to display user interfaces 220 to interact with the game engine 230, The display user interfaces 220, the game engine 230 and the connection manager 240 are also referred interchangeably as the application or web browser 250 throughout the present document. In some embodiment, the application 250 may also comprise all the modules 220, 230, 240 or only one or more modules. Understandably, any other configuration known for running the game on a mobile device and for connecting to the game server may be used without departing from the scope of the present invention.

In game mode, the application 250 is preferably permanently connected to the game server 100. In other embodiment, the communication between the game application 250 and the game server 100 may be intermittent to reduce bandwidth on the network 300. When the application 250 is executed a mobile device, the application 250 ensures a bidirectional communication with the game server 100. During game play, the game server 100 communicates game progress information to the device 200. The application 250 displays the information received from the game server 100 on the device 200. The application 250 is also configured to send information inputted by the participant on the mobile device 200 of the participant.

Prior to play the game, the game application 250 may be downloaded, installed and executed on the mobile device 200. The game application 250 is configured to receive data about the game which are either public and/or private. In another embodiment, the mobile application 250 may be replaced with a server type application executed on the server 100 providing the same features via a web site displayed on a web browser or other client software executed on the mobile device 200.

The system 10 aims at including the organizer, if wished, to participate in a game as a normal participant. Even if the characters or roles are assigned to participant prior to starting the game, the outcome of the game is not know to the organizing participant, similarly to other participant. The system 100 further provides changing the pace of the game and changing the ending or adding side stories. During a first phase of the game, the server may prompt the participants react in different ways. Based on the reaction of the participants, on the profile of the participant and/or on the game history, the server program 110 is configured to change, integrate and affect the actions of a character and/or roles to maximize satisfaction of the participants and/or to trigger certain reactions of the participants.

In a preferred embodiment, a game includes many participants and a plurality of characters. The system 10 may assign a character or a role to each participant based on the characteristics contained in the profile of the participants. Each game may include main roles and secondary roles. During a game, the game application 250 installed on the mobile device 200 of a participant is configured to receive information and instructions directly impacting the outcome of the game.

In some embodiments, a participant may be assigned a secondary or minor role, the game server 100 is configured to create an atmosphere and disturb the revealed clues or strategies of other players by communicating specific instructions to the participants having a secondary role. A participant (player or organizer) may or may not be aware that his assigned character/role is a main/secondary role as such information y may be part of the game intrigue. In some embodiments, the information relating to the type of role may be sent from the game server 100 to the mobile device 200 of the participant without being displayed on the said mobile device. Understandably, the present invention is not limited to main and secondary roles, other categories or types of roles could be used without departing from the scope of the invention.

In embodiments using application program 250 running on the mobile device 200, the application 250 is configured to receive information and/or instructions from the server 110. The said information and/or instructions may general information shared with all participants or may be personalized information for a specific participant or more than one participant (i.e. one or more specific characters or category of characters). In a preferred embodiment, the application 250 is configured to display information elements in the interface 220, aiming at settling atmosphere of the game play. Such information elements are preferably displayed by the application 250 to minimize search effort of said information and increase the player's satisfaction.

In a preferred embodiment, the application 250 must first be installed on the mobile device 200 prior to playing the game and/or registering to the game. For installation, the application 250 may be first transferred or downloaded on the mobile device 200. When the application 250 launches on the mobile device 200, to the application 250 establishes a connection with the game server 110 through the network 300.

In a preferred embodiment, to gain access to the application 250, a user must authenticate with the game server 110. Typically, the user inputs a user name, such as an email address or unique name and a password. If the user is not yet known by the game server, the game application offers an option to create a new user account. Of course, a person skilled in the art will understand that any other means of authentication known in the art could be used.

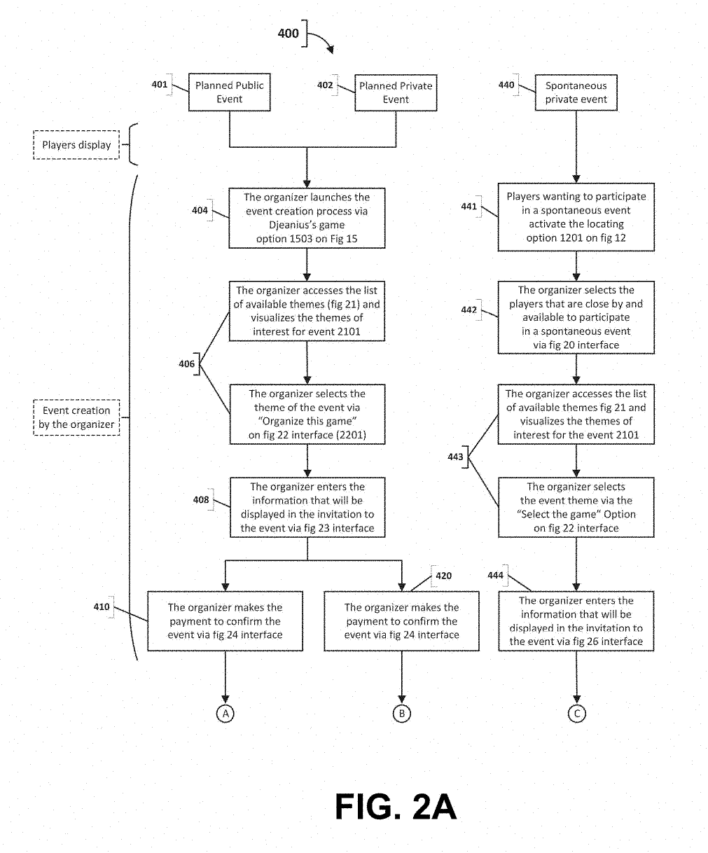

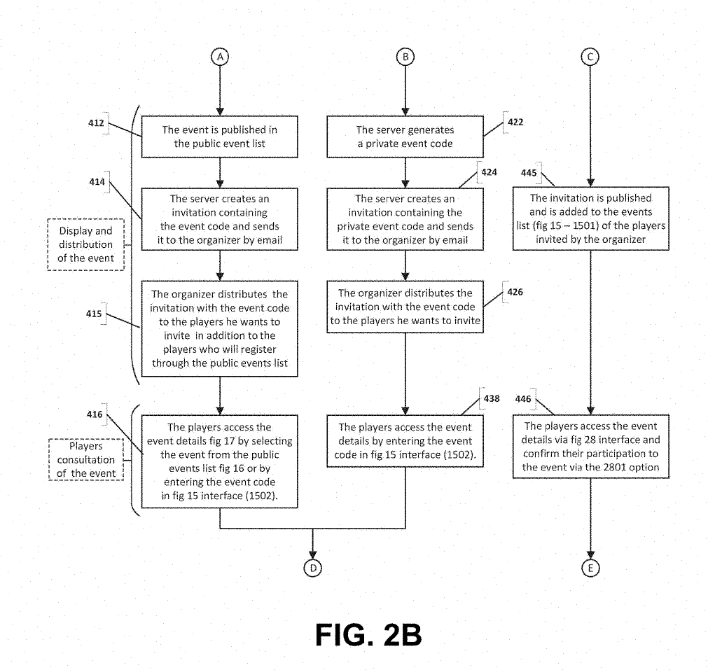

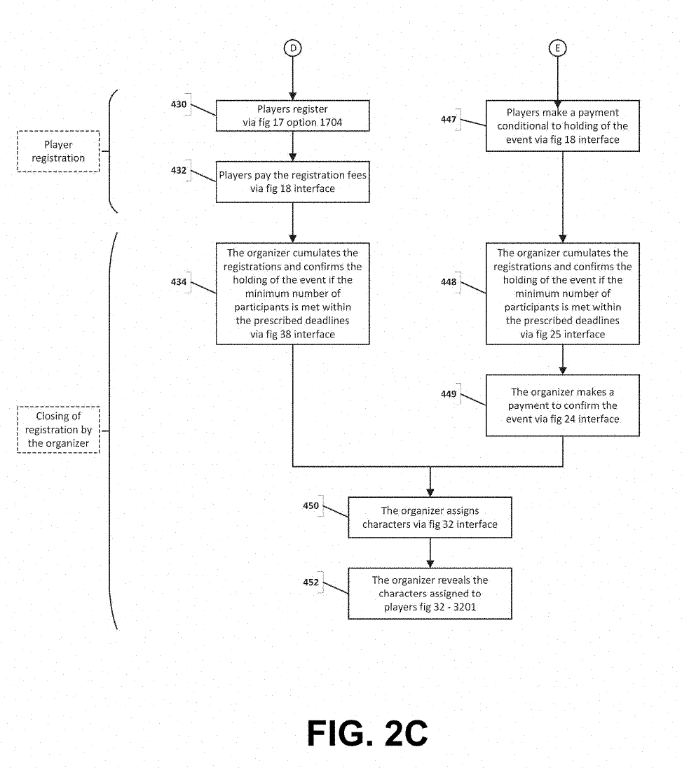

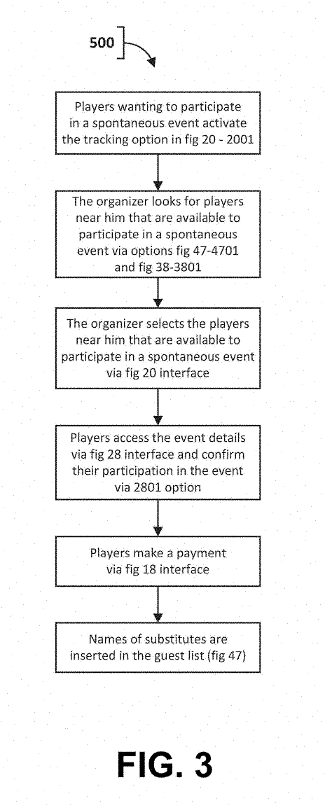

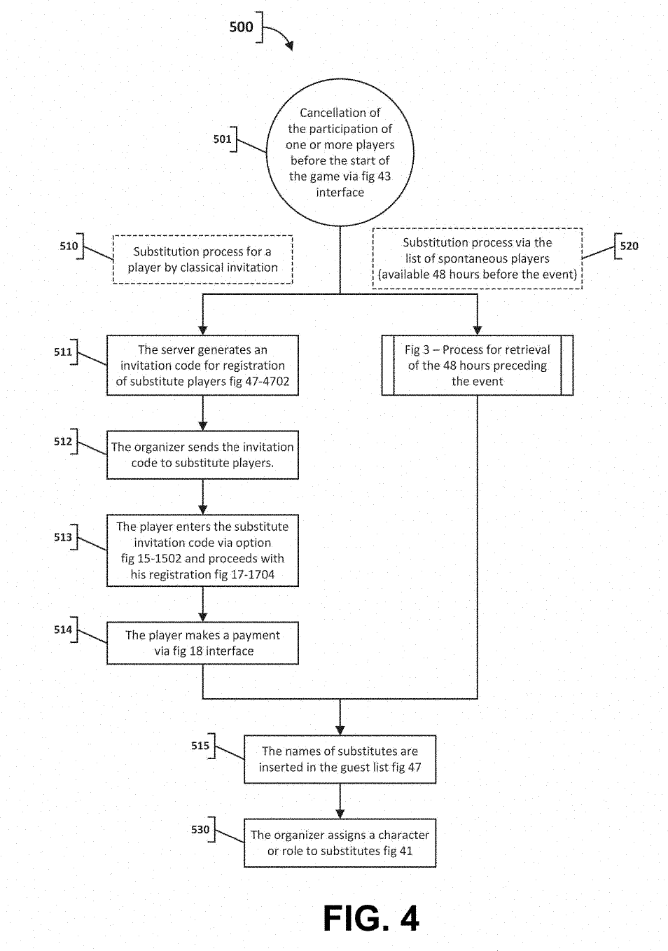

Referring now to FIGS. 2A to 2C, a method to setup a new thematic game 400 is provided. The method 400 may be executed to setup at a predetermined time a public thematic game 401, a predetermined private or restricted thematic game 402 or a spontaneous private event 440. Broadly, for each type of event, the method 400 comprises creating the event, publish or communicate the created event to potential participants, the invited participant accessing to the details of the event, the invited participants registering for the event and closing the registration to the event. To subscribe to a game, the user may register for a planned or spontaneous event or create a new event. Invitations to these events may be private, semi-private or public.

For public and private predetermined events, the method 400 comprises triggering the creation of a thematic game 404 on the game server 110. The method 400 may further comprise selecting a theme from a predetermined list of themes 406. In other embodiments, a default theme may be applied to the game at creation step 404. The method 400 may further comprise inputting a custom invitation message 408 to be sent to the participants.

The method 400 may further comprise paying the registration fees for the game, either for a public event 410 or a private event 420. The payment step may be either executed for all participants to be registered at once or each participant may be invited to pay a registration fee. Understandably, such step 410 or 420 is optional as in some embodiments registration process may be without fees.

In embodiments where the event is public 410, the method 400 may comprise publishing details of the created game or event on a public register 412. Upon publication of the event 412, the game server 110 generates a unique identifier for the event 414. Such identifier may be communicated to the organizing user by any means of data communication, such as by email, SMS or other known means.

In a preferred embodiment, a public event is an invitation made available to all participants registered on the game server. Typically, only the organizer or some designated users may invite participants registered on the game server 110. As an example, public events may be displayed in the application 250 of a participant.

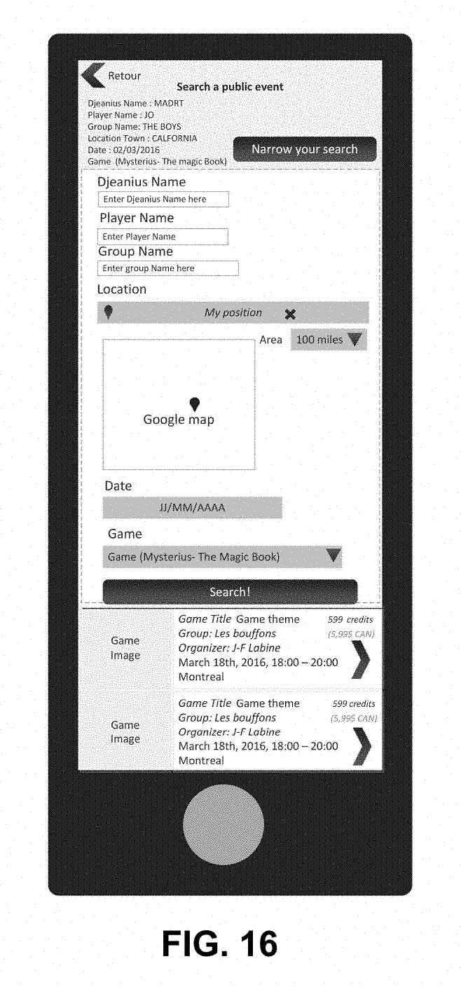

The game application 250 may allow access to all public events to be held on the game server 110 within a predetermined period of time. As an example, public events may be displayed via the interface as shown in FIG. 16. In a preferred embodiment, events are presented in a dropdown list format. For instance, each listed event may display information about an event such as but not limited to, an image, the game title or theme title, the group name, the date, the time and location of the event, the language in which the guidelines will be sent to all players, and finally the registration fees by participant. Information of interest may further comprise the size of the group, the age of eligibility of participants, a personal message from the organizer and/or criteria of ranking for the game. Of course, a person skilled in the art will understand that other information and data display methods can be used while respecting the principles of the current invention.

As an example, the mobile application 250 may further be configured to display the details of an event in the list. The mobile application may further be configured for a user to press within the display zone of the simplified context for this event.

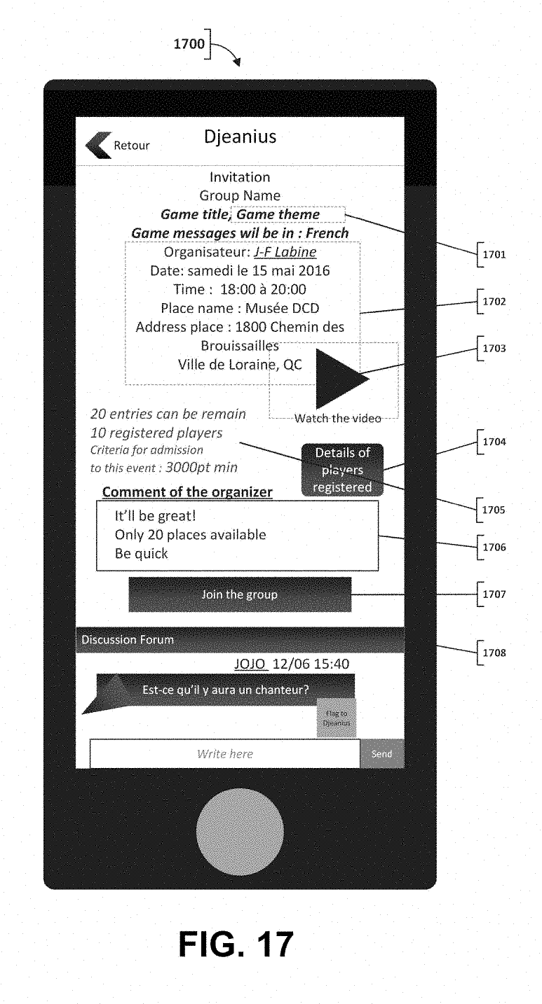

In such an example, an interface displaying details of each event 1700, as shown in FIG. 17, comprises but are not limited to, information relating to the identification of the game 1701, details relating to the event organization 1702 and 1706, the game presentation video 1703, the availability and registration criteria 1705, the list of registered players 1704, the access button to proceed with registration of the game 1707, the discussion forum for the event 1708 or all other pertinent information related to the chosen event.

The interface 1700 may comprises an event forum 1708 configured to be accessible to all registered users and allow all users interested by the event to join the organizer to, for example, ask questions. In a preferred embodiment, while the registering period is active, the forum is accessible to all users. When the registering period has ended, accessibility to the forum is modified to restrict access to the players registered to said game.

In yet another embodiment, the application 250 is configured to send a request to the game server 110 such as a request for listing events. The said list of events may be ordered and/or may be segmented according to the size of the mobile device display area, so as, for instance, to avoid saturating le mobile device's application memory and/or limit the data transfer to information visible by the user.

The application 250 may also comprise filtering events compatible to the criterion entered by the participant or to the profile of the participant. As an example, FIG. 16 illustrate an interface comprising a filtering options configured to limit the search of events. Filter options may comprise but are not limited to the location, the date, the game thematic, the organizer and/or the circle of friends or acquaintances. Filters may be applied in combination to target events quickly and efficiently.

Still referring to FIGS. 2A to 2C, the method 400 further comprises sending an invitation to potential participants or publishing the public event on a public game registry 415, the invitation preferably comprising the unique identifier of the event and/or a link to the event detail page. An invited participant may then access the details of the public event to be held at a predetermined time and location 416.

In embodiments where the event if private 420, the method 400 may comprise the game server 110 generating a unique identifier for the private event 422. Such identifier may be communicated to the organizing user by any means of data communication 424, such as by email, SMS or other known means. The method 400 further comprises sending an invitation to potential participants or publishing the private event 426. An invited participant may then access the details of the private event by accessing a restricted page 438, such as by inputting the received unique identifier.

A private event is typically restricted to people to whom the organizer sends the specific code of the event. The invitation does not appear in the list of public events and the event details are revealed to invited players when they enter the specific event code (see, for instance FIG. 17).

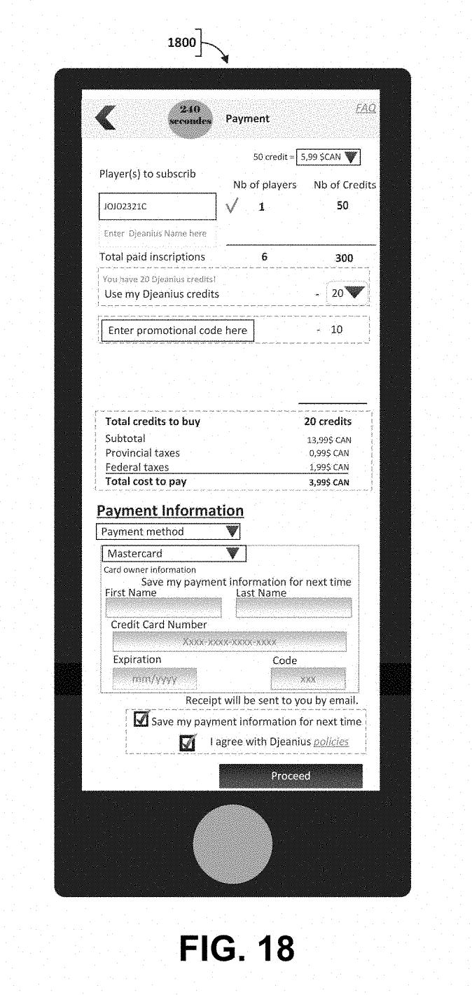

For any type of event (i.e. private or public), the method 400 further comprises the invited participants to register to the event 430. The registration of the participant 430 to a public or private event is typically done through a detailed interface of the event 1700 (as shown in FIG. 17). If the registering period is still active or open, the mobile application 250 displays an access button on the registration interface 1707. The exemplary registration interface 1800 (as shown in FIG. 18) comprises an option to pay the participation fees and to formalize the game registration. If the registration period is closed, the mobile application 250 may display a message indicating that the registration period has ended.

If needed, the method 400 may comprise paying the required fees 432. The method 400 further comprises the processing the registrations and confirming the event if all conditions are met (i.e. minimum number of participants reached, payments received, etc.) 434.

For spontaneous private event 440, the method 400 further comprises a potential participant localizing spontaneous event in a predetermined geographical radius or publishing the coordinates of the mobile device to the game server 441.

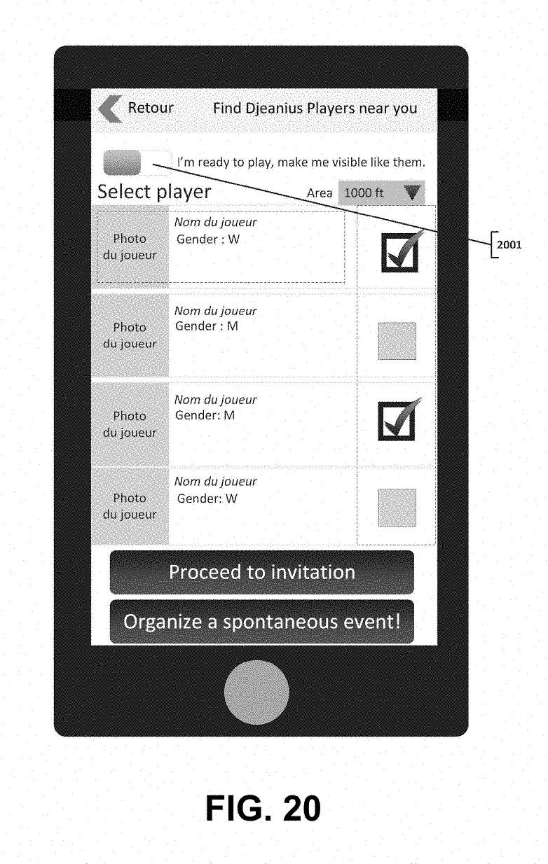

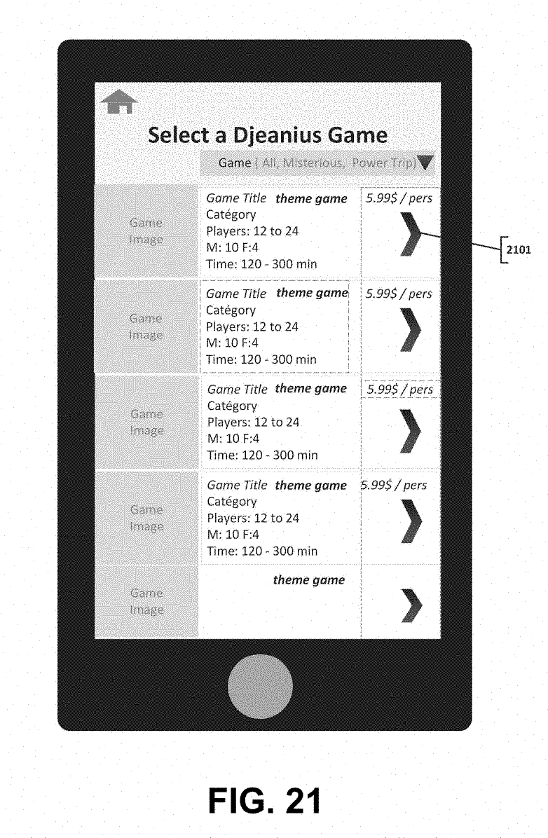

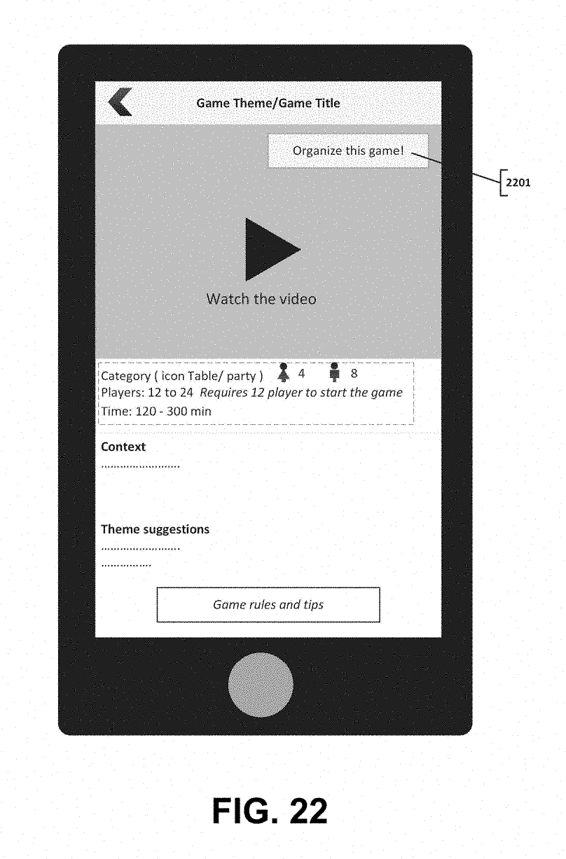

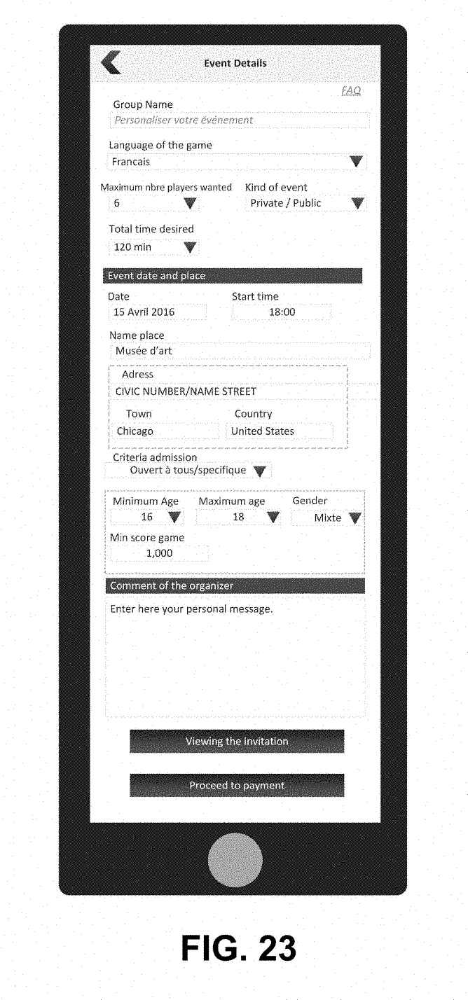

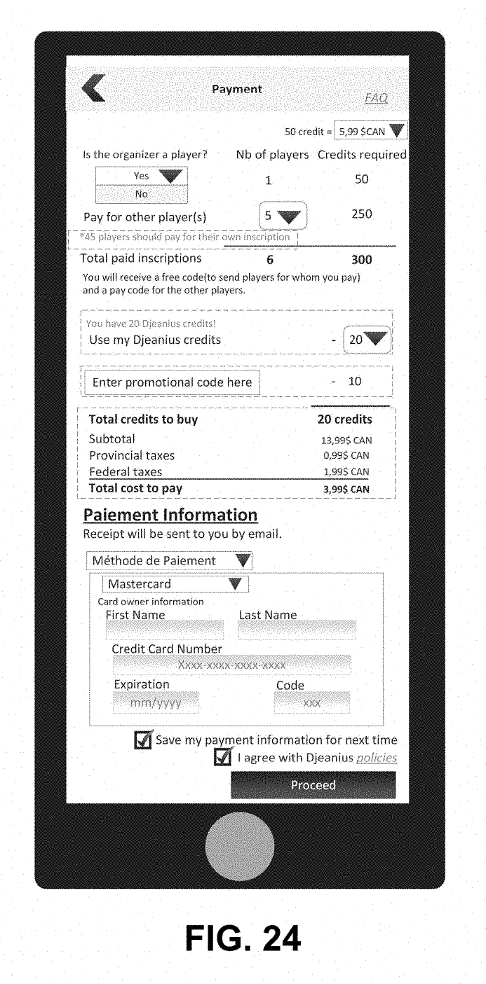

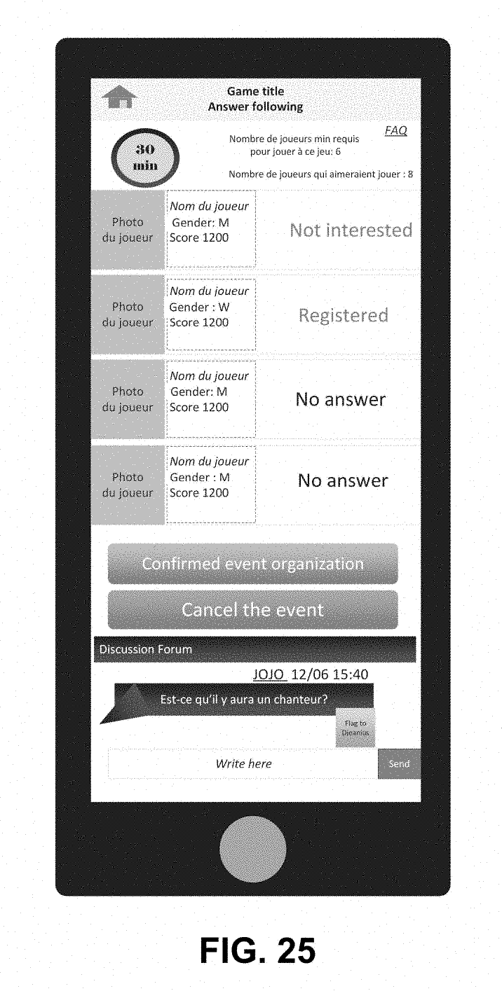

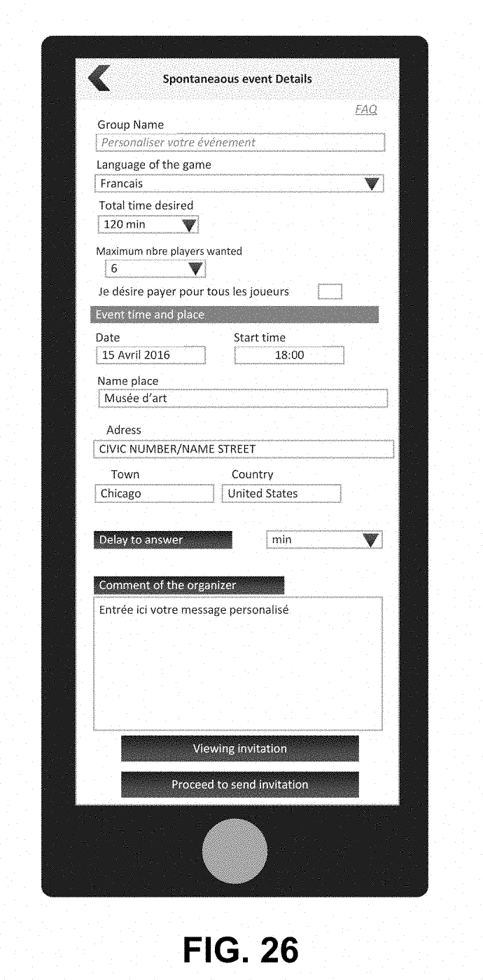

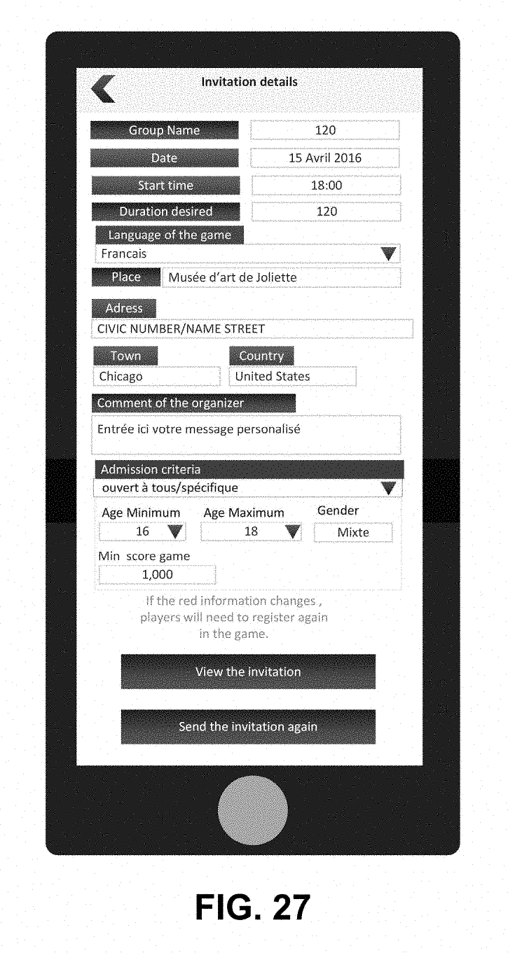

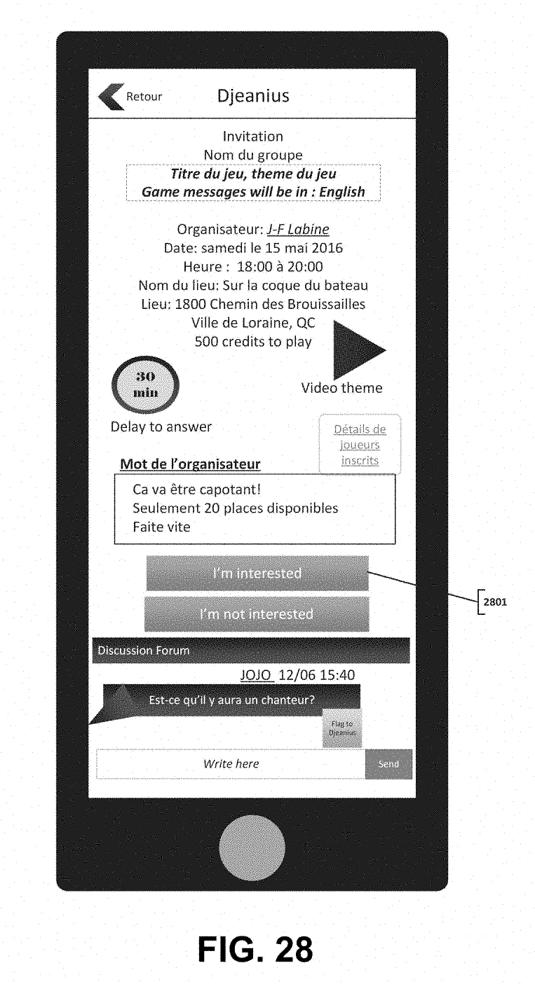

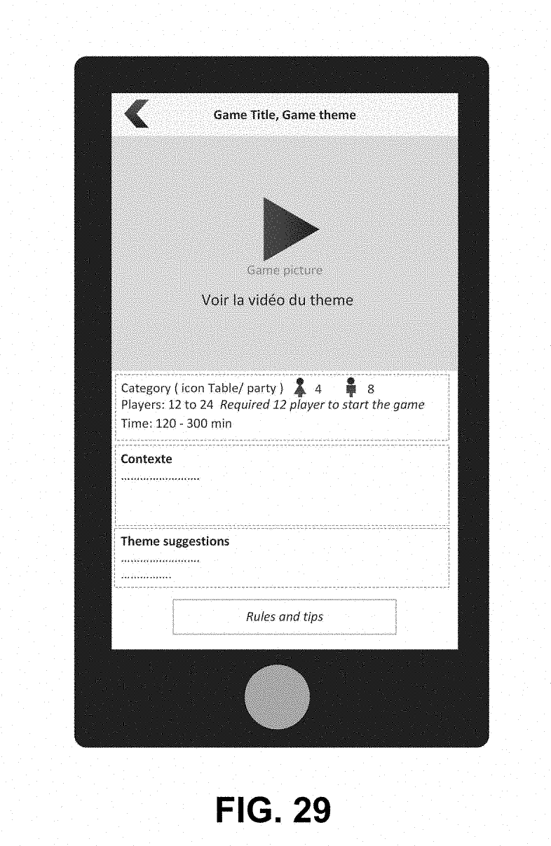

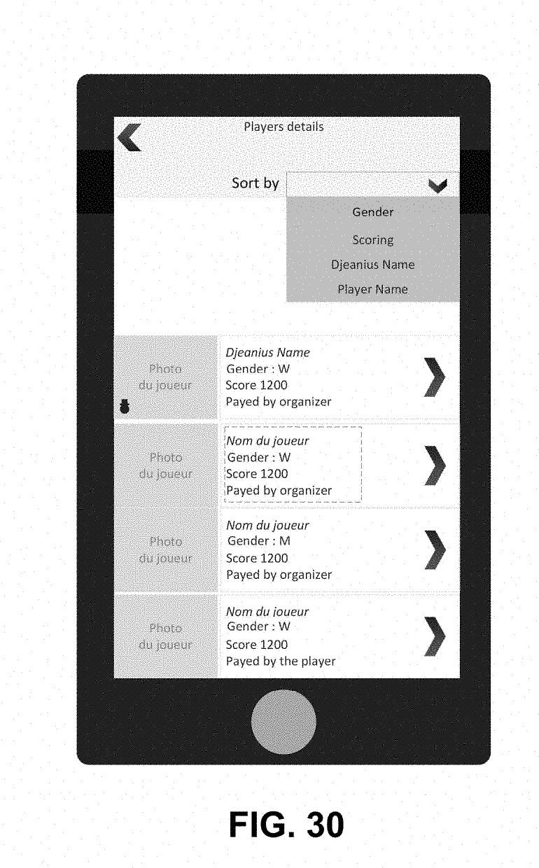

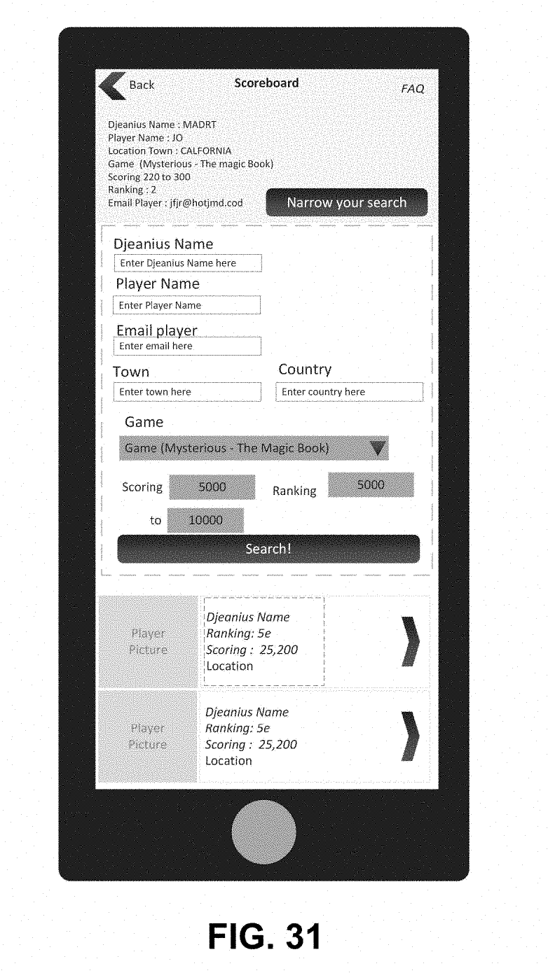

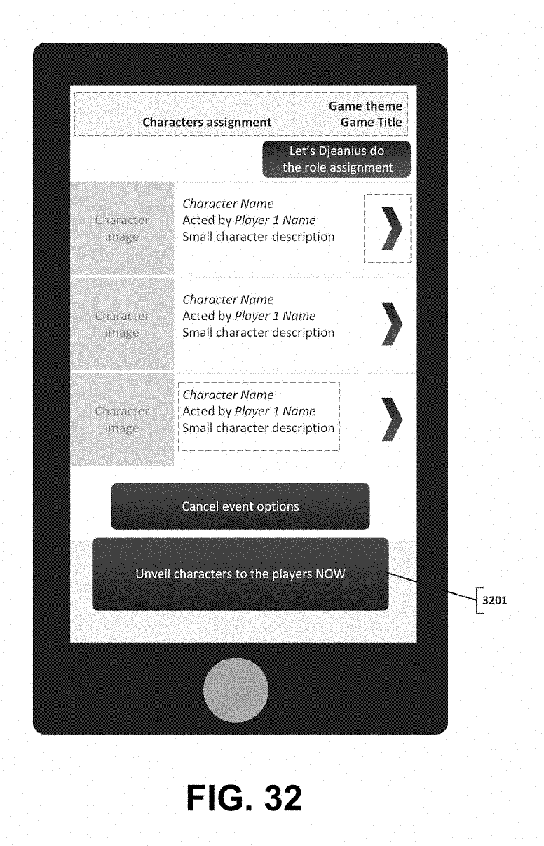

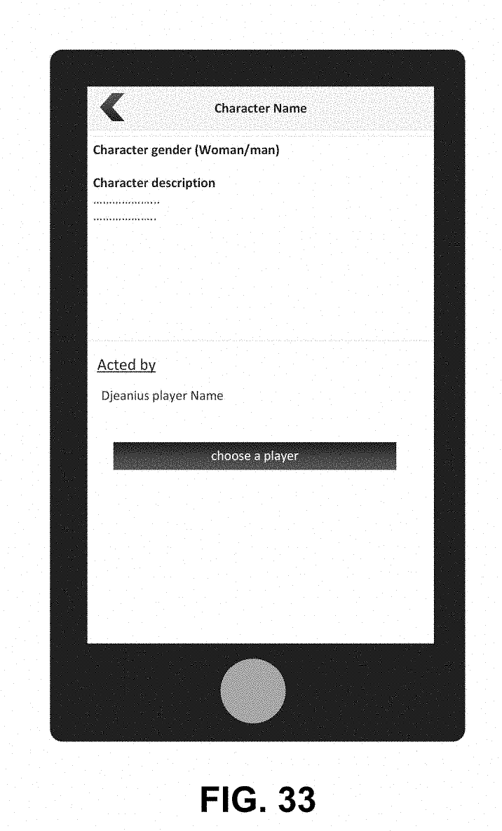

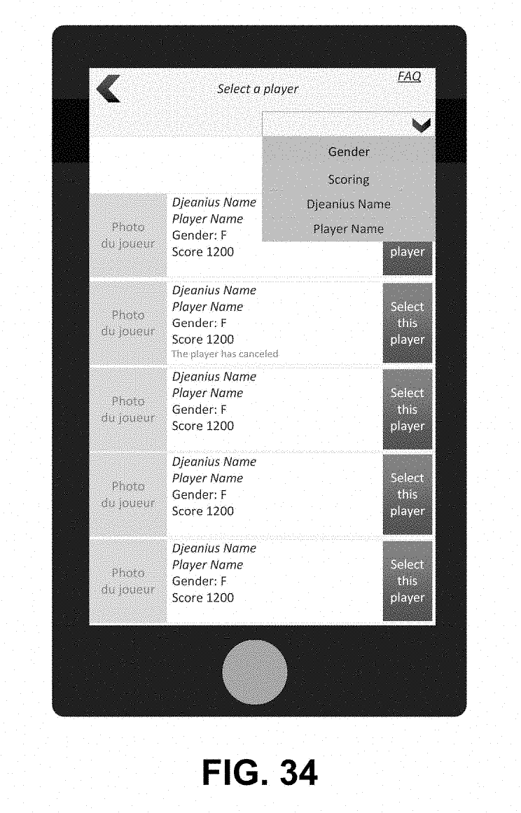

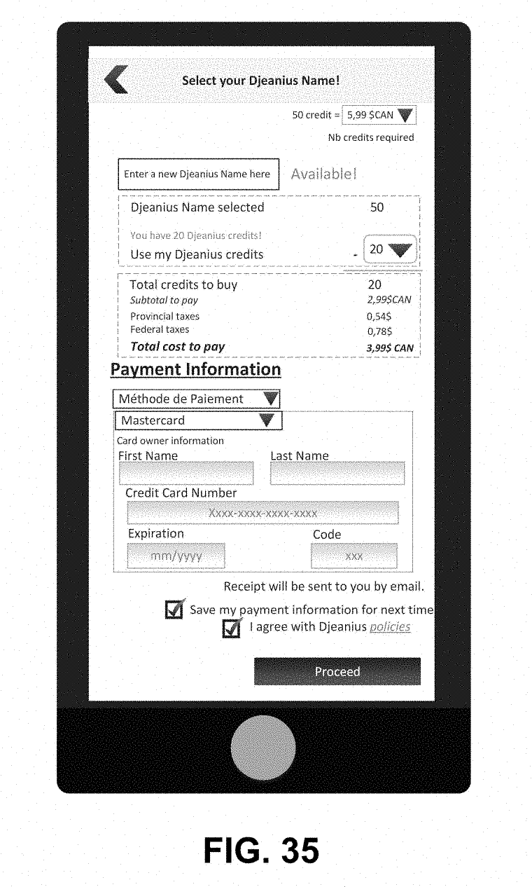

In a preferred embodiment, if a participant wishes to take part to an improvised/spontaneous event in the next few hours, the participant uses the application 250 to trigger the publication of the availability of the participant to other members of the community. In yet another embodiment, the application 250 may publish the geographical coordinates or localization information of the mobile device 200 to other members of the community. Upon publication of the localization information and/or availability, the application 250 communicates with the server 110 to add the participant to the list of available players for spontaneous events and/or to the list of players available to substitute a player who cannot come to the event. As shown in FIG. 20, a locating interface displays all players registered to spontaneous events and located within a predetermined perimeter.

The method 400 further comprises the organizing user selecting interested participants in the area 442. In a preferred embodiment, a participant wishing to organize a spontaneous event selects from a list of players available for a spontaneous game 442. The method 400 may further comprise selecting a theme from a predetermined list of themes 443. The method 400 may further comprise inputting a custom invitation message 444 to be sent to the selected participants in the area.

The method 400 further comprises sending an invitation to selected participants 445 (similarly to 424), the invitation preferably comprising the unique identifier of the event and/or a link to the event detail page. The server preferably creates an invitation for each player 445. A time limit is preferably set by the organizer participant and is associated with the invitation.

An invited participant may then access the details of the public event to be held at a predetermined time and location 446. The invited and interested players to the spontaneous event may also confirm their participation 446 using the application 250. The confirmation is preferably communicated to the game server 110. The organizer is typically notified of the reception of the player's acceptance.

If needed, the selected participant pays the required fees 447. In a preferred embodiment, the payment may be preauthorized or not to be added to the list of participating players.

The method 400 further comprises the processing the registrations and confirming the event if all conditions are met (i.e. minimum number of participants reached, payments received, etc.) 448. In embodiments where time duration is set, when the invitation duration is lapsed, and if the game criteria are respected, such as the number of players, the organizer uses the application to confirm the event. The application 250 preferably communicates the confirmation to the game server 110. In a preferred embodiment, the application can be configured to request payment of registration fees 449. Once an event is confirmed, the game server may send a confirmation or notify the application of the confirmed players that the event will be held.

The method 400 further comprises, for any type of events, assigning characters to the registered participants 450.

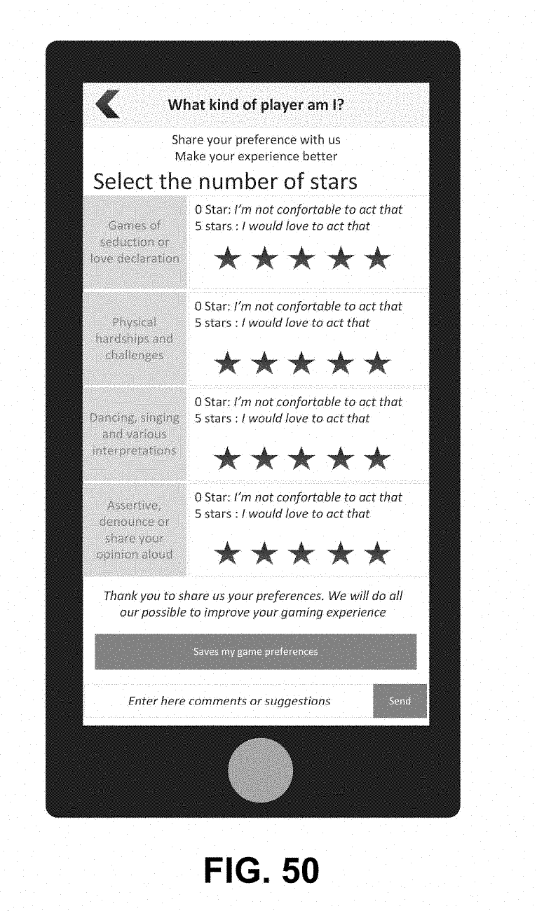

In a preferred embodiment, the game server 110 automatically identifies roles and options compatible with a profile of the participant. In such an embodiment, a profile may be associated with each participant. Such profile may be completed using an interface of the application (see for instance FIG. 50). The profile of the participant may comprise physical skills, tastes, preferences, mood and social status. Understandably, any other type of profiling known in the art could be use, such as using other accessible profiles, such as Facebook™, Linkedin™ accounts.

In an embodiment using a local profile, the application 250 displays a questionnaire. The participant answers to the questionnaire about preferences, aptitudes, opinions or performing small games of skill. Upon reception of the answers, the game server 110 is configured to create a custom characterization of the player that will serve as a comparative base to determine the level of affinity to the various elements involved in the composition of the game, such as: the characters, the scenarios, contextualization, directed actions, complementary stories, mini-interactions etc.

More precisely, each of the characters in the game and the interactive stories can be defined with similar or opposite qualifiers according to the emotional comfort defined in the player's profile. When assigning characters and roles, the server 110 performs a combinatorial algorithm which achieves matching that maximizes the cohesion of the characteristics of each player with the roles and characters.

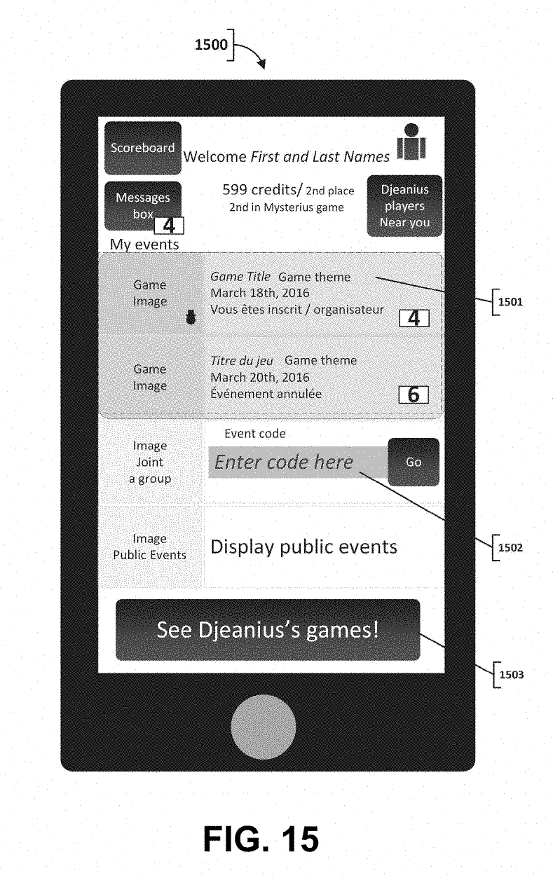

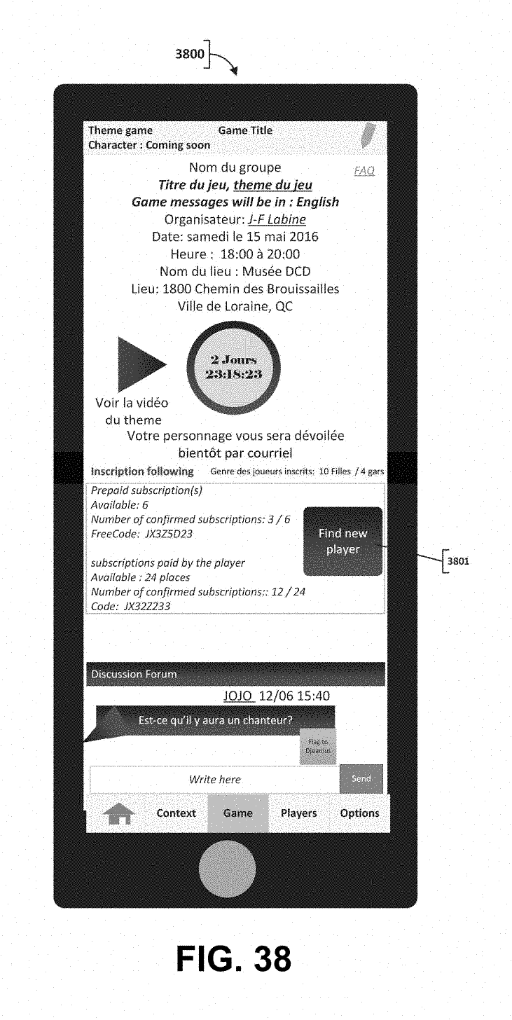

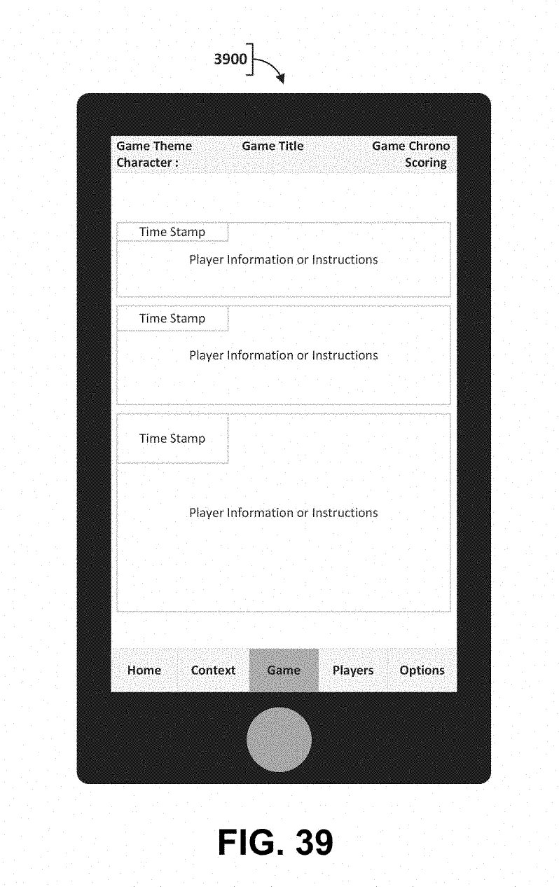

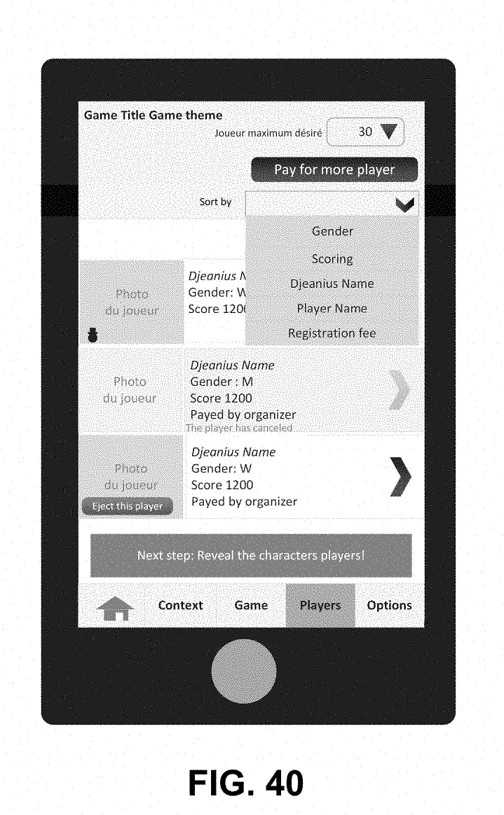

The application 250 typically comprises a main interface 1500 (see FIG. 15). The main interface may be configured to display one or more lists of all events for which the user is registered, invited or is the organizer. From the lists, the user accesses 1) the game queuing interface if he is registered and the game has not yet started 3800 (see FIG. 38), the game interface if he is registered and the game has started 3900 (see FIG. 39), 3) the invitation interface 1800 if he is invited to a spontaneous event (see FIG. 18), 4) the game queuing interface with the event management options if he is the game organizer 3800 (see FIG. 38).

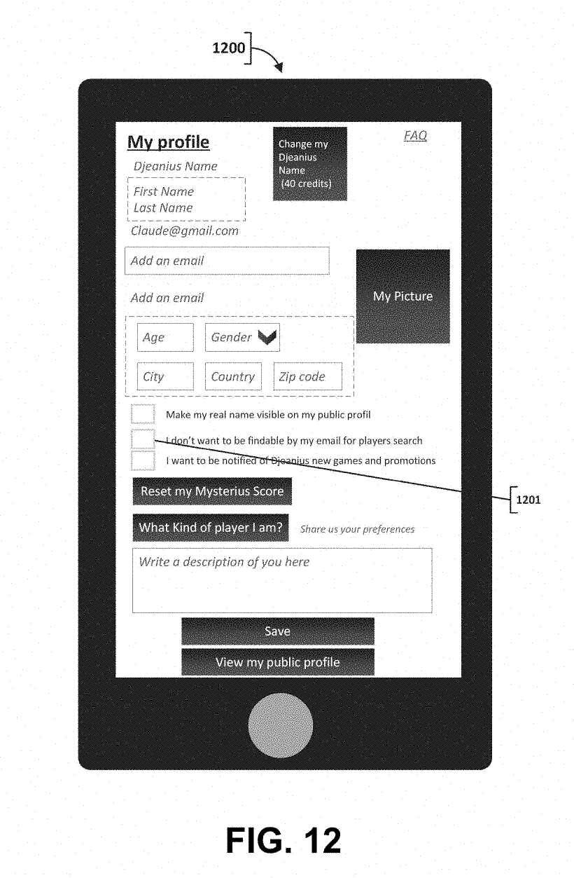

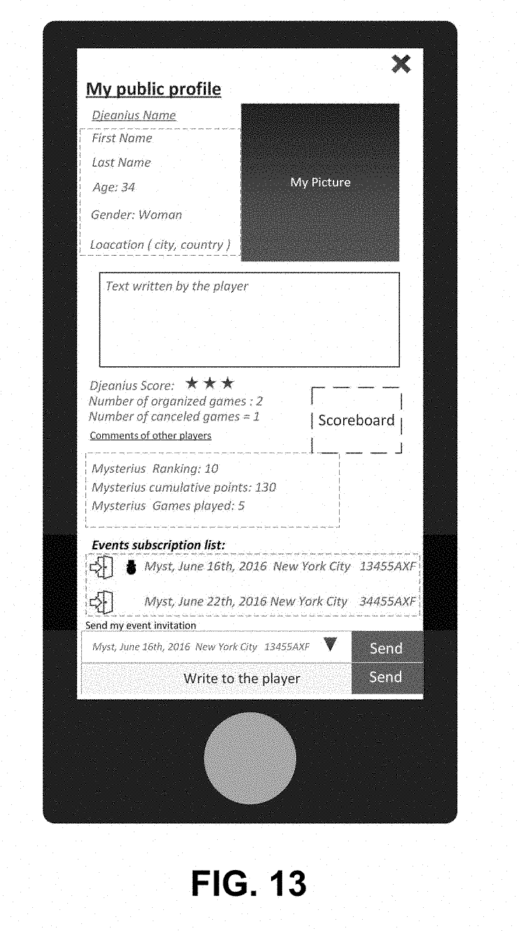

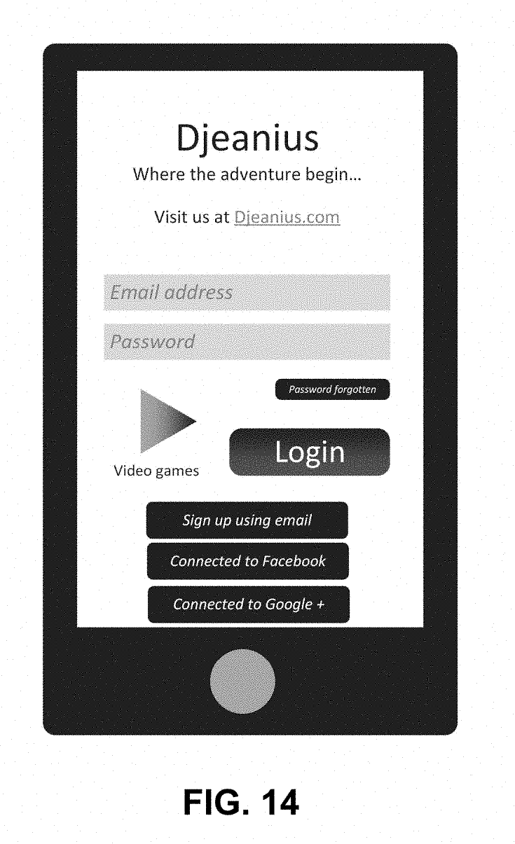

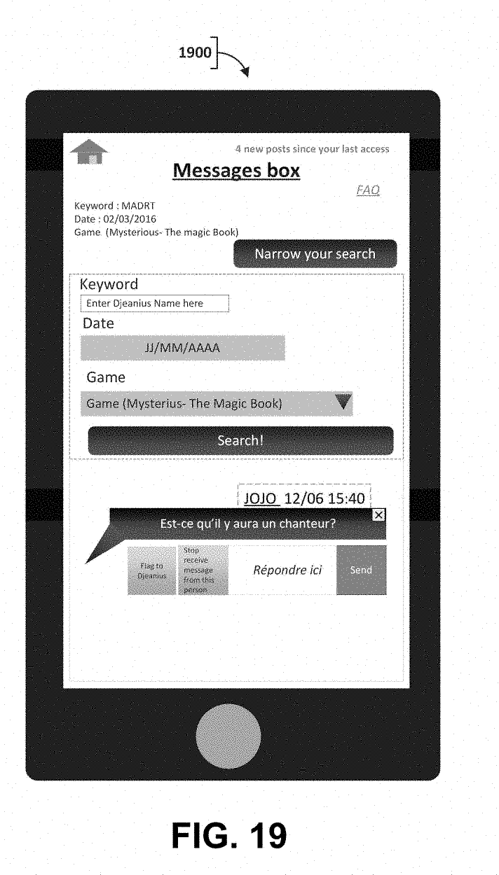

The main interface 1500 may further display personal information of the participant, such as name, ranking and scores for all games, number of credits in the bank, the list of events to which the participant is registered and on standby for registration and direct links to access the participant profile page 1200 (as shown in FIG. 12), access to his private message box 1900 (as shown in FIG. 19), access to the score table of all players registered on the game server and access to the process of locating nearby players for the organization of a spontaneous event or to display his availability. The main interface 1500 may comprise links to event or search function through a list of public events, of unveiling a private event from an event code published by the organizer and the creation of a new event.

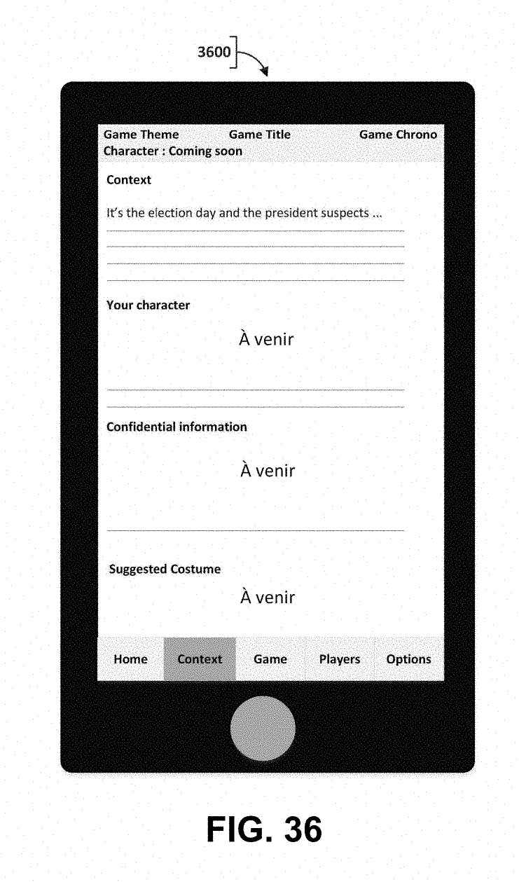

An exemplary interface 3600 (as shown in FIG. 36) displays information about the context of the game during the registration period, when the roles are not yet attributed.

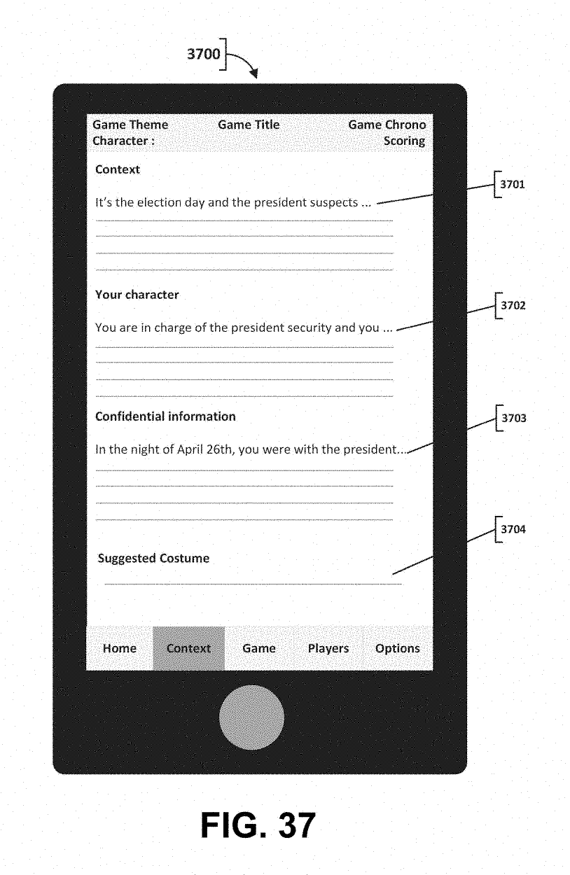

The method 400 further comprises communicating or revealing the assigned characters or roles to the registered participants 452. An exemplary interface 3700 (as shown in FIG. 37) displays the context of the game when registering is completed 434 and roles have been attributed 450. As shown on FIG. 37, the context interface 3700 may comprise descriptive game elements such as but not limited to the staging of the story 3701, the description of the character role of the participant 3702, strategic information 3703 known at the beginning of the game that the player may reveal or not according to the circumstances met during the game, the psychological profile, the attitude, the character traits and finally the physical profile of the assigned character, and/or suggestions for disguises and/or an image of an object/clue 3704. The application 250 is configured to display or provide access to the context interface 3700 during the game and during a predetermined period before starting the game. Typically, the information displayed before starting the game aims at allowing the participant to memorize pertinent information before the game and to adhere to the role of the character assigned both physically by his accoutrement as well as psychologically through his psychic description.

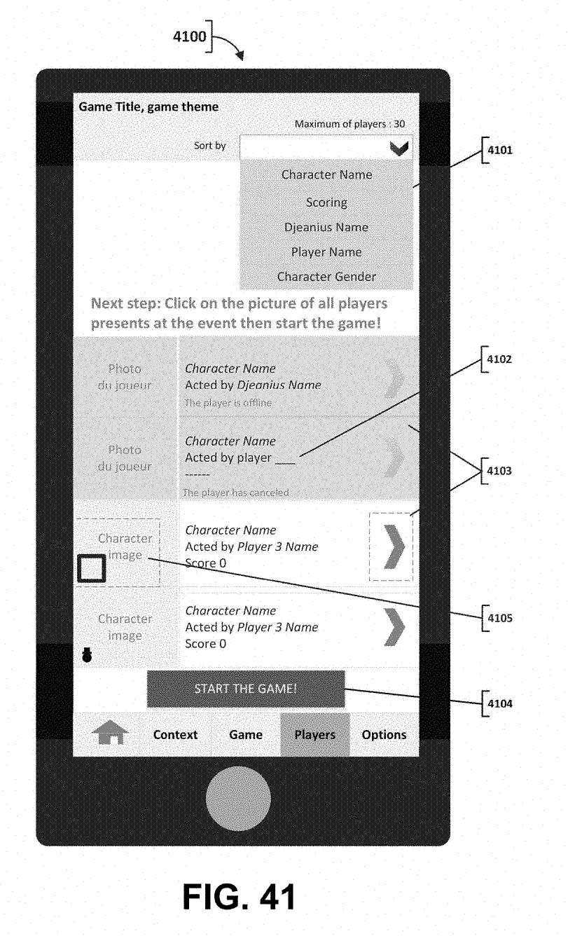

To help participants quickly identify the other characters, understand their role in the proposed theme and evaluate their aptitude, the application 250 displays, typically on a single interface, all players registered in the game. In a preferred embodiment, the information about the participants is displayed in a dropdown list. Typically, as shown in FIG. 41, the dropdown list is ordered 4101 by the name of the character, the name of the player, the type of player or his game score. The players dropdown list 4102 may further comprise the profile summary of the participant. The profile summary may comprise, as an example, the photo of the participant, the name of the assigned character, the real name of the participant, a description of the assigned character and/or the cumulative score of the participant during the game and the player's score in his previous participations.

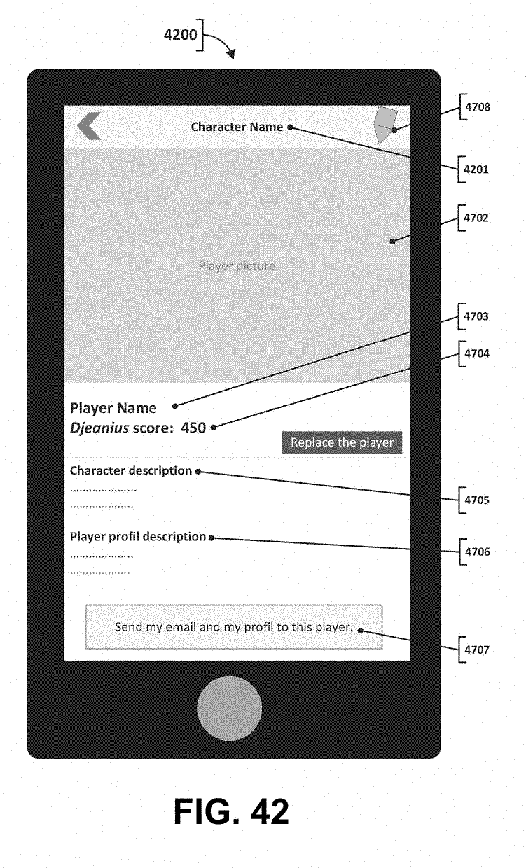

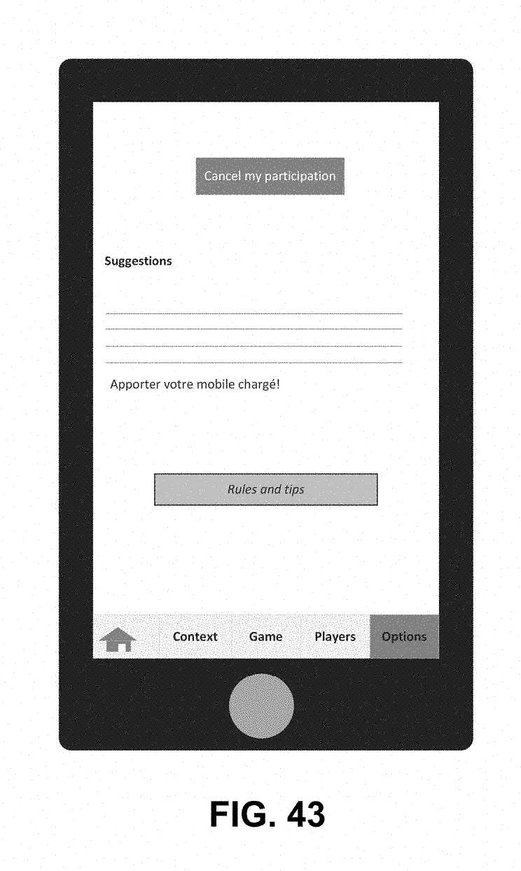

Still referring to FIG. 41, the application may be configured to display the detailed record of a registered participant to the game. As an example, the application 250 may be configured to display the list of participant when clicking on an element of the dropdown list 4103 comprising a summary of the profile summary. Now referring to FIG. 42, an exemplary interface showing the detail of the character is shown. As an example, the interface may display the name of the character 4201, the photo of the participant 4702, the real name of the participant 4703, the cumulative score of the participant 4704, the description of the character assigned to the participant 4705, information from the profile of the participant to publish to other players 4706 and/or a means, such as a button 4707, allowing to send a message, automated or not, such as an email to the player consulted. The message typically comprises the detailed file information and the personal email from the player who wishes to share his information.

The mobile application 250 is configured to display the detailed record of the participant. The application 250 may further be configured to edit the detailed record associated to the player 4708. In edit mode, the player may, modify his photo 4702 and/or personal information 4706. The game server 110 is configured to store the detailed record information. The game server 110 may also be configured to provide access to all registered players to the game for the game duration. The detailed record aims at publishing personalized information about the character and the player to facilitate communication between the players right from the beginning of the game.

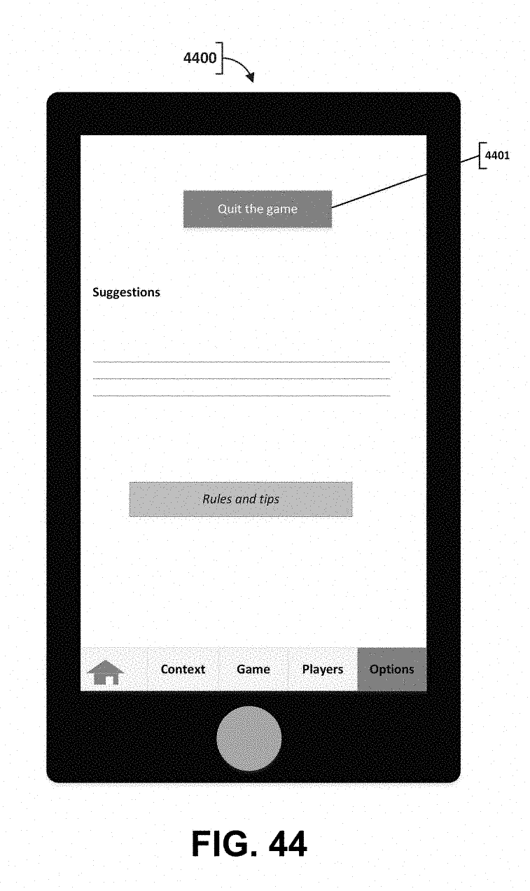

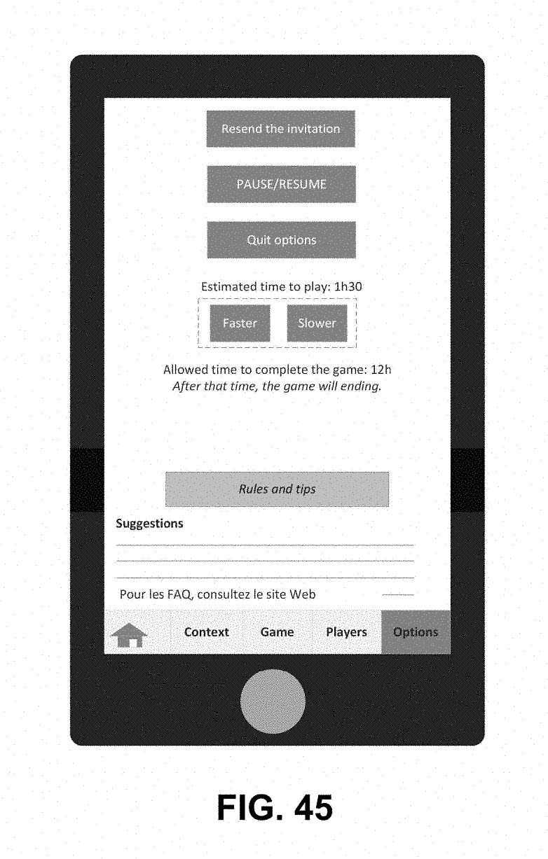

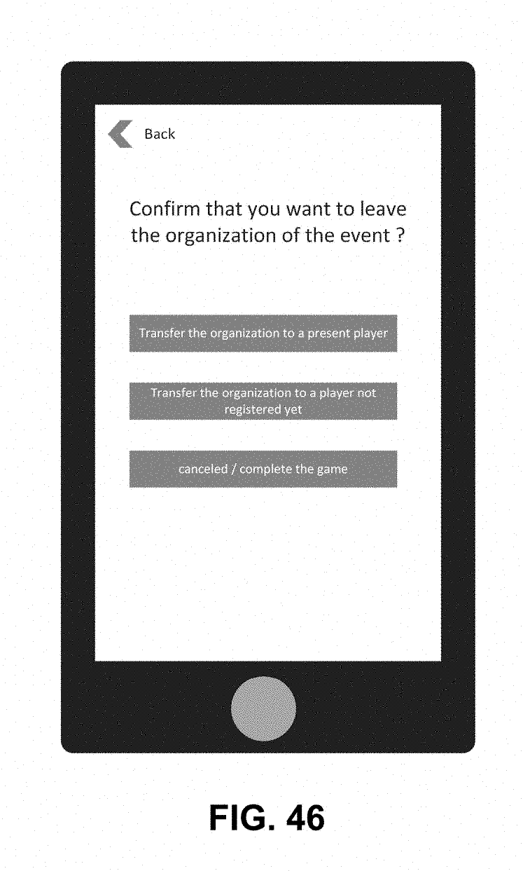

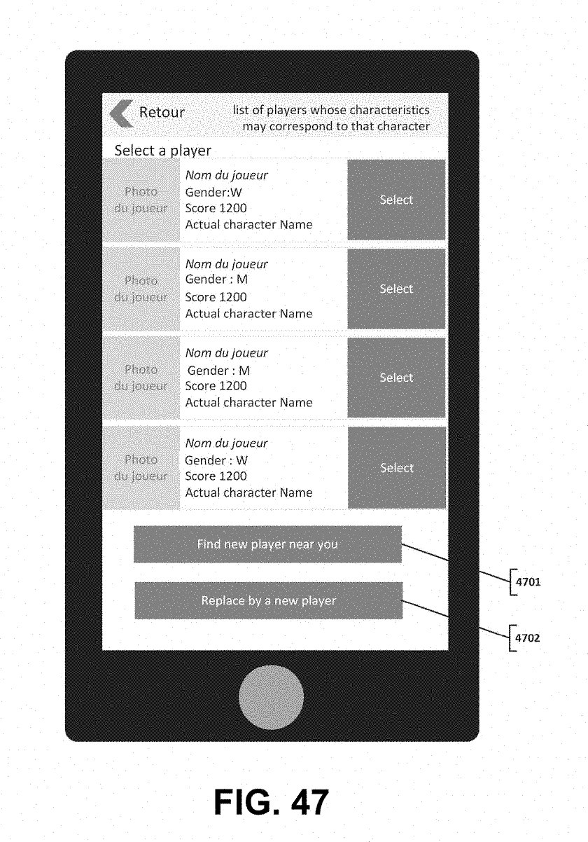

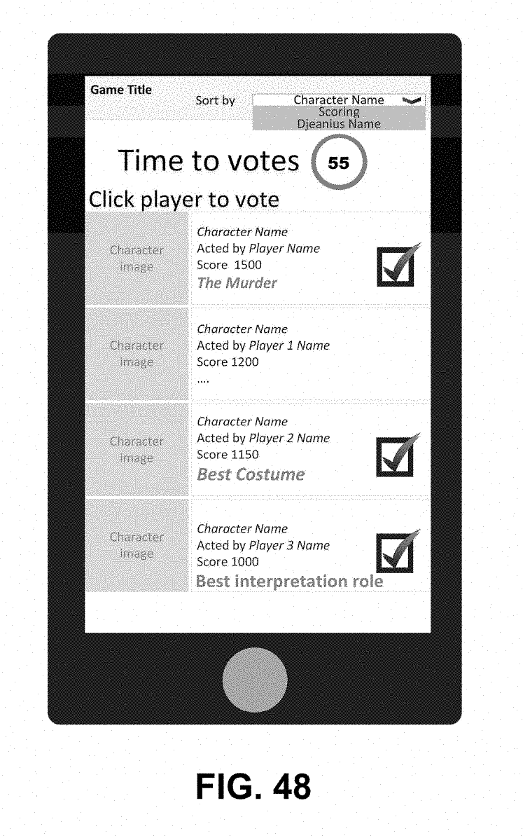

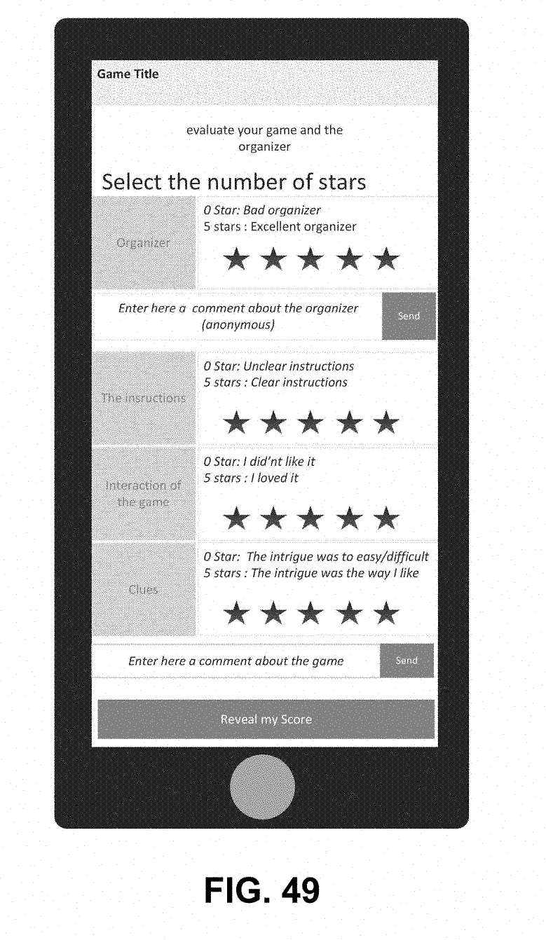

Now referring to FIG. 44, an exemplary interface 4400 to options of the game is shown. The options interface 4400 displays a means for the players to quit the game 4401. In a preferred embodiment, when a player quits during an ongoing game, the server 110 sends a notification to the application 250 of the organizer user. When the game server receives a request to quit the game, it determines if the assigned character is a main character. If the assigned character is a main character, the game server 110 determines one or many potential alternate scenarios allowing the game to run smoothly. If the server cannot identify an alternate scenario, it will suspend the game and notify all the players' mobile applications that the game is suspended.

The mobile application 250 of the organizer player may receive a notification requesting to reassign the character associated quitting participant to another registered player. When the server 110 receives the new assignment, the game server 110 resumes the game and notifies the applications 250 of the participants that the game is resumed.

Similarly, the application 250 of organizer is configured to remove any of the players registered to the game. An organizer may exclude players who, for exceptional circumstances, must be removed from the game. When removing a player, the game server 110 may notify the application 250 of the organizer that the character associated with the player removed must be reassigned to another player registered in the circumstances described above (i.e.: no alternative scenario).

In yet another embodiment, if a substitute participant may not be found or should not be found, the game server 110 may substitute the participant to be substituted with a virtual player. The character incarnated by the outgoing or absent player remains displayed in the list of active characters and may interact with the other players, such as via the game interface 220. The active participants may continue to interrogate the virtual player by accessing the profile of his character to find relevant and revealed information in time on that player as the game server 110 would have done with the actual player. To make the experiment more realistic, the information to be revealed may be presented in an abstract form using alternative texts intended to conceal or deceive other players.

Depending on the type of game, the virtual player may further use the same virtual diversion tools available to other “real” participants. Such tools may be used only by the virtual player to improve his score, his position as leader or his survival. To do this, the game server 110 may use scripts or artificial intelligence programs to control the activation of the virtual tools to one or more players. As an example, the virtual player may use virtual tools in the following scenarios: protection of points or advantages acquired by the virtual day in response to an attack according to its severity, increasing of score or benefit by detecting opportunities and launching attacks, animation of passive players by forcing them to commit themselves and take part in the game. To reduce the predictability of the virtual player, the decision may be weighted by a random function.

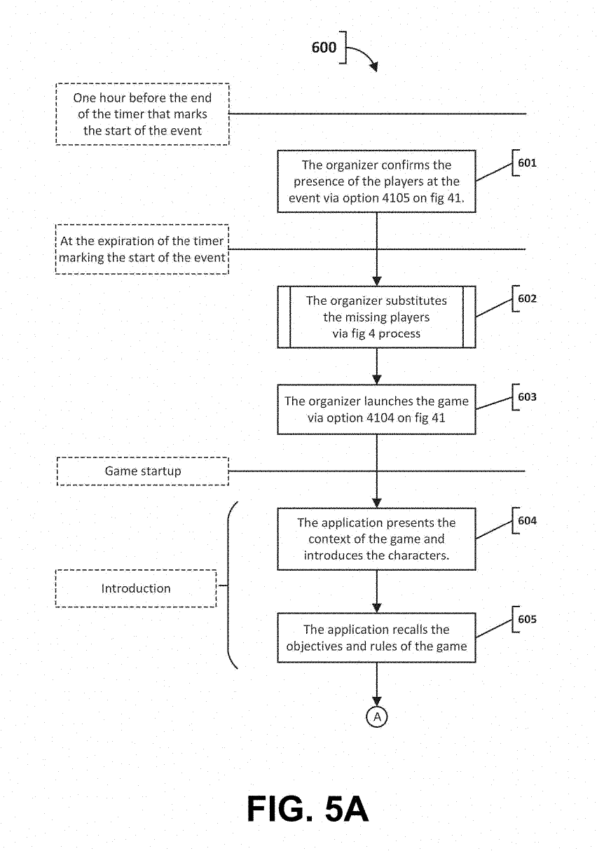

Now referring to FIG. 4, a method to change or substitute a registered player prior to the beginning of the game 500 is shown. The method 500 is generally triggered when a registered player cancels his participation prior to the predetermined start time of the game 501. The method 500 may either uses a typical invitation process to the game 510 or select a player from the list of participants available for a spontaneous game 520.

In a typical invitation scenario 510, the method 500 comprises the server 110 generating an invitation and a unique identifier associated with an invitation 511. The method 500 further comprises communicating the unique identifier to the desired substitute participants. The invited participants may than request registration or confirm the invitation using the invitation unique identifier 513. If needed, the participant pays the required fees 514. Upon reception of the confirmation and/or the payment, the server 110 adds the confirmed participant to the list of registered players for the game 515.

If the method 500 uses the selection of a player from the list of participants available for a spontaneous game 520, the method 500 generally follows the steps of the setup of a game 400 to invite available players in a predetermined radius (see steps 441, 442, 446, 447). The method 520 further comprises the server 110 adding the substitute participant to the list of registered players for the game 515.

The method must further comprise a step to assign a character or a role to the substitute player 530.

Now referring to FIG. 39, an exemplary main interface 3900 displaying information and instructions specific to the participant is shown. Such information/instructions may be sent in real-time. The main interface 3900 is preferably designed to minimize the attention of the participant to the instructions in order to maintain the focus of the participant on the plot, strategies and reactions of the characters in the game. The main interface 3900 preferably displays short, precise and sequenced instructions according to the progression of the game scenario. In some embodiments, each instruction is divided and spaced from other instructions to limit the time to read and locate the keywords in the instructions.

The game server stores in the data source 120, such as a database or file, all or part of the instructions received by the application 250 of each participant during the game. These instructions may be displayed in a game history interface.

Instructions requiring an action for a specified period may be identified by means of a way for determining the period remaining or elapsed since the start of the action. The active chronometer synchronized on the game server is typically decreasing. For instance, the chronometer may indicate to the player the time remaining to carry out the instruction sent. This active chronometer is a distinctive element of the game which can, for instance, be used by the game server to: 1—evaluate the player's participation by calculating his response time, 2—synchronize interactions between players, 3—force a player to reveal more through quick and closely sequenced instructions, 4—or allow a player to remain inconspicuous by giving him more time.

The basic elements of a game generally comprise a theme, characters or role assigned to participants, a contextualization, instructions to players, revelation of information sequenced in time and decision making or opinion based on the revealed information.

To this basic assembly, the game may also include scenarios and controlled interactions that alter the dynamics of the game and stimulates the player's interest.

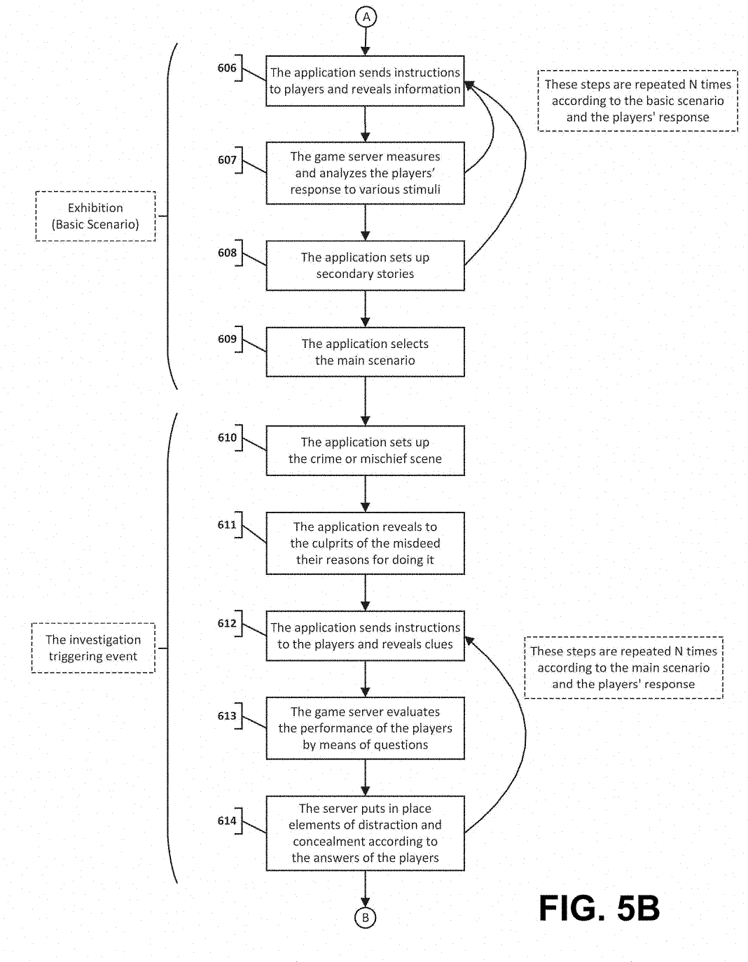

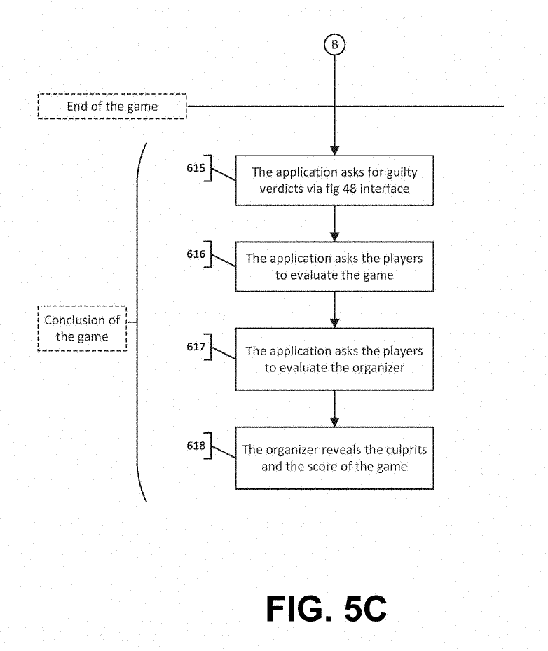

Now referring to FIGS. 5A to 5C, a method to execute an investigation thematic game 600 is provided. The method may comprise confirming presence of the participants to the event 601. Such confirmation may be sent at a predetermined time prior to the beginning of the game, such as one hour prior to the start of the game. At the predetermined time of the start of the game, the method 600 may comprise substituting a missing player 602, such as using method to substitute a player 500. The method 600 further comprises starting the game 603. The starting of the game may be executed manually by the organizing user or may be automatically triggered by the game server 110.

The application 250 of each participant than displays the context of the game and/or the description of each characters 604. The method 600 may further comprise displaying the rules of the game 605 in the application 250.

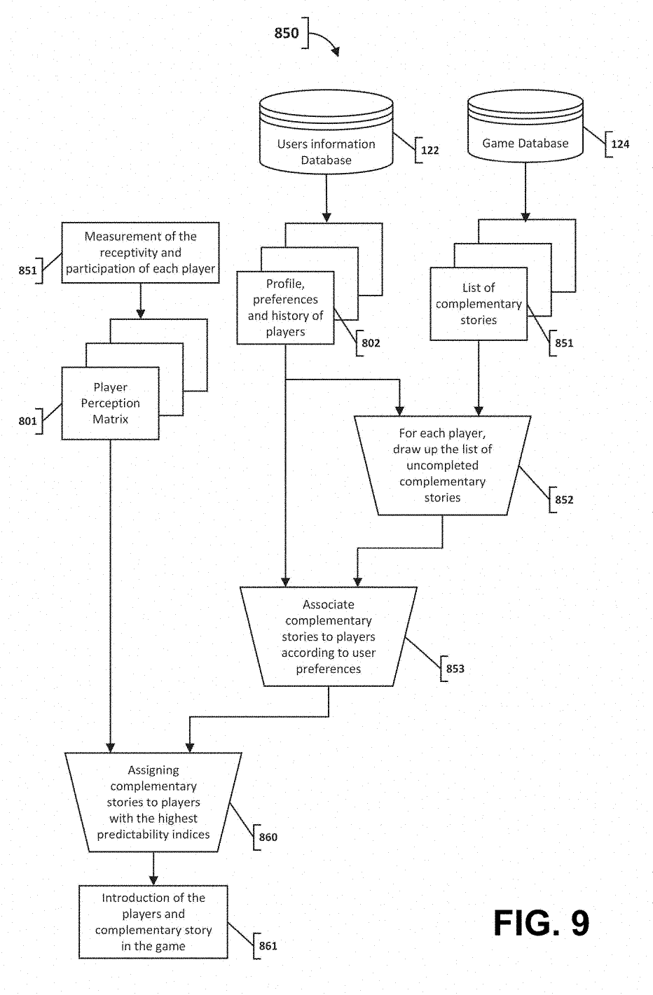

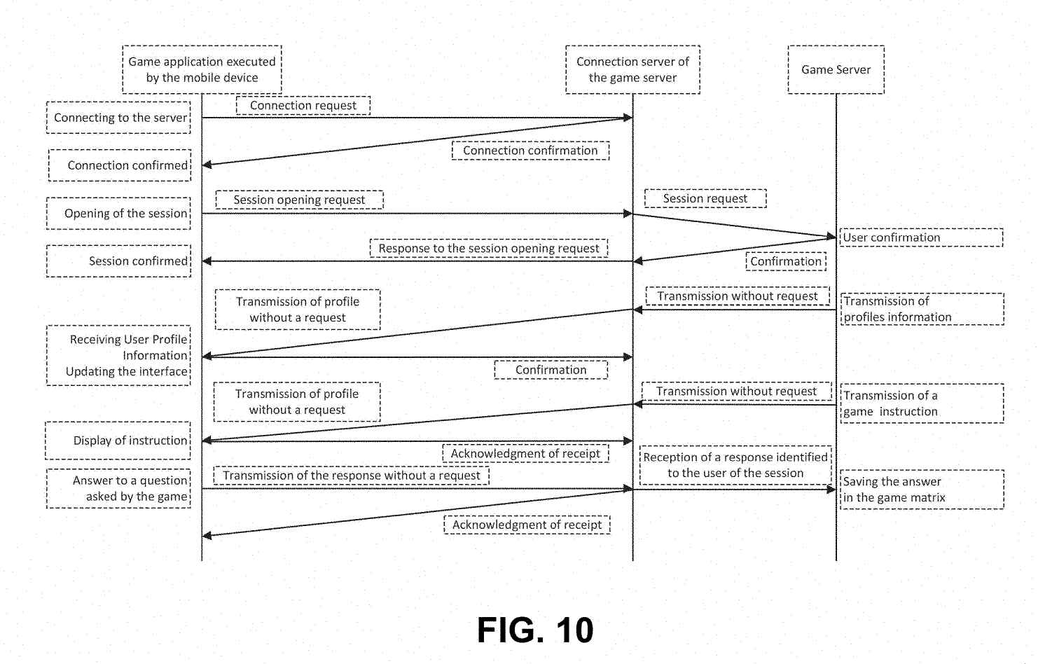

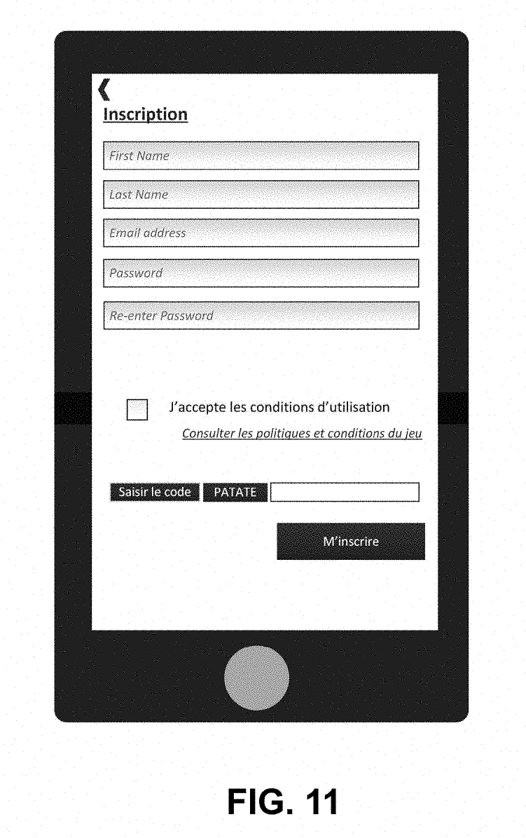

The method for executing an investigation thematic game 600 further comprises the application 250 displaying instructions and information about the game in a timely basis 606. The participant may input answers in the application 250 based on received instructions. The game server process and analyze the received answers in reaction to different stimulus 607. Based on the reactivity of the participants, the game server may execute side stories 608 (also shown at FIG. 9). The steps 606, 607 and 608 may be repeated N-time by the game server 110 during the game. The method 600 further comprises the game server/application selecting the main scenario of the game 609.

The method 600 may broadly comprise providing a triggering event and an investigation. The application/game server displays information about the committed crime 610. The application/game server displays only on the application 250 of the one or more participants associated to a role being responsible for the triggered crime 511. The application/game server communicates instructions and/or hints about the crime 612. The method 600 may further comprise calculating or evaluating the performance of the participants through evaluation means 613, such as questions. The method 600 may further comprise sending instructions to participant aiming at distracting or dissimulating elements based on answers of players 614. The steps 612 to 614 may be repeated N times during the game play of the scenario.

After predetermined duration or if triggered by the organizer, the game comes to an end. The method 600 further comprises requesting the participants to vote for the one or more characters responsible for the crime 615. The method 600 may further comprise requesting feedback on the game 616 and on the organization team or user 617. The method further comprises displaying the responsible of the crime and/or the scores of the participants on the application of the participants or the organizer user revealing such information manually 618.

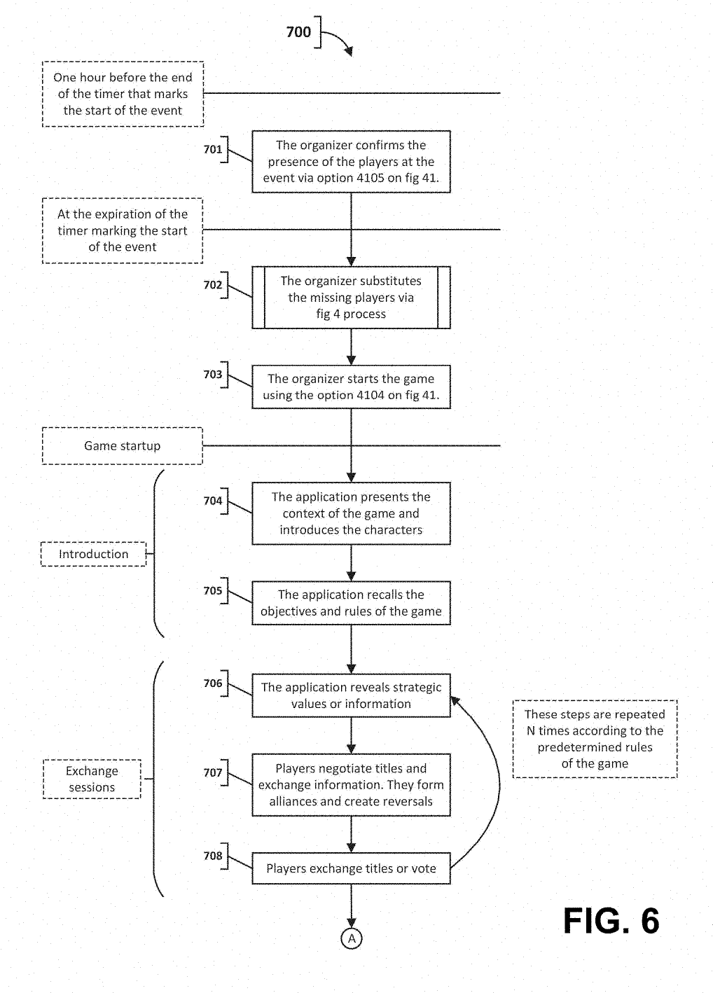

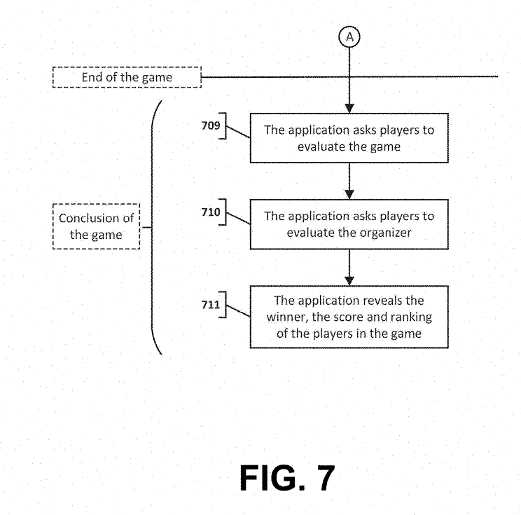

Now referring to FIGS. 6 and 7, a method to execute a survival or power rising thematic game 700 is provided. Similarly, to the method of an investigation game 600, the method 700 may comprise confirming presence of the participants to the event 701. Such confirmation may be sent at a predetermined time prior to the beginning of the game, such as one hour prior to the start of the game. At the predetermined time of the start of the game, the method 700 may comprise substituting a missing player 702, such as using method to substitute a player 500. The method 700 further comprises starting the game 703. The starting of the game may be executed manually by the organizing user or may be automatically triggered by the game server 110.

The application 250 of each participant than displays the context of the game and/or the description of each characters 704. The method 600 may further comprise displaying the rules of the game 705 in the application 250.

The method 700 further comprises managing an exchange session. During such session, the application/game server provides to the participant relevant values or strategic information 705. The method 700 may further comprise the participants exchanging information and titles, creating alliances and reverting alliances 707. The application/game server provides a mean to exchange titles, to vote for the strategic participants or to vote for the elimination of participants 708. The steps 706, 707 and 708 may be repeated N-time during the game play.

After predetermined duration, or once there is only one survivor, or if triggered by the organizer, the game comes to an end. The method 700 may further comprise requesting feedback on the game 709 and on the organization team or user 710. The method further comprises displaying the winner of the game and/or the scores of the participants on the application of the participants or the organizer user revealing such information manually 711.

In a preferred embodiment, the execution of the investigation game is generally subdivided into 5 distinct stages. These 5 stages can be:
Contextualization: revealed before the game starts, this stage reveals information as to where the action takes place, the time, the scenery, but also the characters and their characteristics;
Introduction: When the game server receives a request to start the game from the organizer's mobile application, the game server sends the start time of the game to the players' mobile applications. The server can also be configured to send a contextualization and possible exchange between players. During this stage, the player can get acquainted with the rules and objectives of the game;
Exchange and voting sessions: This stage introduces players, within the game context, elements for trading, such as fictitious goods to barter and strategic information to use or to reveal to the end of acquiring as many points as possible or eliminate opponents. If applicable, trades and securities transactions made between players during the game session are entered, recorded and displayed to all players through the game interface. Each step is often marked by a voting session putting players in opposition. This stage is carried out in loops until the end of the game; During this stage, the game server sets up gap-leveling strategies by increasing the difficulty of the leaders versus the other players;
Game conclusion: This is the stage where the game is ended and publication of the players' score and ranking is done. The game server processes all votes received from the mobile applications of the participating players. The game server is also configured to calculate and communicate player rankings to players' mobile applications.

In an investigation game, algorithms are developed mainly focused on concealing clues while maximizing the overall player satisfaction index. To achieve this goal, the game server uses different strategies

### The Selection of the Scenario According to the Preferences of the Active Players

As it appears in the example of the scenario selection process 800, the scenarios known by the players are first eliminated. The game scenario is then selected to correspond to the one offering the greatest compatibility index between the actions of the scenario and the most active players.

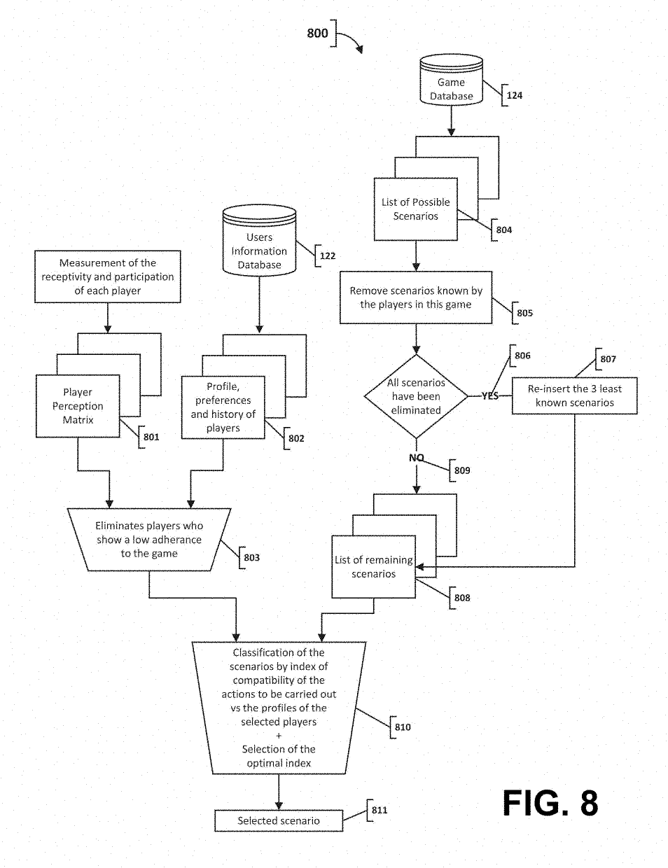

Now referring to FIG. 8, a method to select one or more scenario 800 is shown. Aiming at increasing the players' satisfaction, the game server generally record throughout the game, different measures that allow evaluation of the player's adherence to the game and the player's receptivity to instructions to adjust game parameters and adopt a personalized operating mode compatible to each of the players.

The method comprises the game server creating decision matrices on the perceptions of the participant to the present game 801. The method 800 may further comprise creating a profile comprising data relating to the participants 802, such the predictability of the issue, the level of comfort of the participants, the participation rate and training, etc. In a preferred embodiment, the data is fetched from a data source comprising information about the users 122. The method 800 further comprises using decision algorithms based on the cumulative information of these matrices to remove players having low adhesion to the game 803. Such measures generally aim at allowing the server to identify actions aiming to increase participation, astonishment and destabilization of the players in their presumptions.

The method 800 further comprises fetching all possible scenarios 804 from a game data source 124. The method 800 further removes all scenarios already known or played by the participants in the game 805. If all scenarios are removed from the list 806, the method 800 identifies the less known or played scenarios and reinserts such scenarios in the list 807. If the list 805 comprises at least one scenario 809, a list of the remaining scenarios is created 808. Based on the list of remaining participants 803 and on the remaining scenarios 808, the method 800 classifies the scenarios based on the profiles of the remaining participants 810. The method may calculate an optimal ratio 810 used to select the relevant scenario 811.

### Introduction of Side Stories

Now referring to FIG. 9, a method to introduce side stories in the main scenario 850 is illustrated. The method 850 may introduce side stories depending on the predictability index of the scenario, measured by the game server for each participant. The predictability index may be calculated by using various techniques such as prediction algorithms. For instance, the predictability index could be calculated by measuring the deviation between the score associated with a correct answer and the score associated with the response from the player. Side stories are associated to players according to their user preferences and their game history.

The method 850 generally comprises measuring for each participant the receptivity and the index of participation 851. Such measurements are added to the matrix of perception of the participants 801. The method 850 further fetch profiles, preferences and historical data of participant 802 and available side stories 854 to select the side stories being non-used for each participant 852. The profile data 802 is associated to the selected side stories based on the preferences of the participants 853. The preferred side stories are then assigned to participants having the highest predictability index 860. The side stories being associated with the highest predictability index is then introduced in the main scenario 861.

### Integration of Spontaneous Interactions

Similarly, when introducing side stories, the game server 110 may analyze participation responses and may send instructions and hint to some participants to distract the said participants being focused on solving the investigation or the most strategic. The game server 110 generally controls interactions with the said participants to add atmosphere to the game while creating distraction. For instance, the game server may analyze such aspect by measuring the time and accuracy of the response from the player.

### Addition of Concealment Information

When responses or answers provided by the participants are too coherent with the game, the application server 110 communicates information to the application 250 of participants being unrelated to the game strategy to drown the information and force the players to absorb a greater number of variables in their logic of resolution. For instance, the server 110 may analyze the coherence by comparing the score obtained by the players' responses to a predefined value.

### The Pace of Interactions

When the responses are too coherent, the game server 110 deduces that players have enough time to think and solve the puzzles. The server 110 may be configured to increase the pace of at which the information is sent and to reduce the accepted response time. Such process generally aims at increasing the stress of the participants and generally aims at creating the euphoria in the game. For instance, the server 110 may analyze the coherence by comparing the score obtained by the players' responses to a predefined value.

In a game of gain or ascension to power, the skills of the player to manipulate or deceive opponents are put forward. In that case, the matrix aims at reducing the gap between the players to preserve the winning expectation for all players until the end of the game. To reduce such gap, the server 110 uses many tactics as the score difference increases between the leaders and the average of the other players. One of these tactics is to increase the pace for some specific participants, such as the leaders, so they have less time to prepare and cause errors due to stress. Another tactic is to increase the level of complexity of actions, options or queries offered to the leaders versus the other players. The same techniques used for the investigative games are deployed.

### Use and Description of Virtual Diversion Tools

Playing on a mobile device allows the integration of virtual diversion or entertainment tools in a form that is non-existent in table games. The said diversion tools may be assigned to participants, at the beginning of a game or may be acquired during the game, such as being obtained in exchange of points, credits or achievements, or being purchased from the game server 110 or application provider. The virtual entertainment tools may vary based on the type of games being played. As an example, the virtual tools may provide to a participant various actions, such as but not limited to imposing a beneficial or punitive action to other players; exploiting an extrasensory function allowing access to hidden information, acquiring an armor or privilege to counter or to exempt from an obligation imposed by the game or player.

Virtual diversion tools associates one or more action to one or more characters to whom the action is directed. As an example, a participant may press a “Blind” icon on the mobile device and select character “A” assigned to a participant, the mobile device 200 of the participant receives information that is the character is blinded for a predetermined duration. This action may result in the application 250 to instruction the participant assigned to the character “A” to close his eyes or the interface of the application darkens during the delay imposed by the action.

Other tools allow, for example, transforming or revealing an index or information or a character by using the augmented reality. As part of the game, the organizer or players take photos of elements and players who are present in the game environment. During the game play, the elements are captured using the camera and are displayed on the screen of the mobile device 200 in a different or modified format in order to disclose a new information revealed by the game.

### Active Sensor and Server Action

To maximize the players' experience, the application server 110 stores and compiles all information relevant to the gaming environment variables and the level of enthusiasm of the players. Such information is processed to apply selected game models, such game models generally aiming at promoting the cohesion of the players during the game. To capture such information or clues, the application 250 may use of integrated sensors of mobile devices to measure environment variables such as room luminosity via the camera and/or movements of players to measure the exaltation and reaction of participants to an instruction. Using historical satisfaction scores and the said sensory measurement taken, the application server 110 runs an artificial intelligence program to target the players having a potential of feed the game according to their profile and reactivity. The artificial intelligence program may further create interactions and virtual entertainment tools that have been statistically most valued in these same circumstances.

The historical satisfaction index is typically determined by a statistical method based on information gathered from the historical records of the previous games. More precisely, satisfaction indices are partly evaluated by polling the players at the end of each game, but also calculated from converging favorable results determined by iteration of profiled time series on measures aggregated in whole or in part of the following elements: the location, the profile and preferences of the players and organizers, the place, time and period of the year of events, of answers to questions, response time, players restlessness (measured by the accelerometer of mobile devices), variations in audio intensity (measured by the mobile device microphone), the biorhythm, the number of steps and movements, breathing, light intensity, the sense of observation (for instance, using images displayed quickly, jerky or displayed in part), the speed of execution, voting results, edited instructions, scenarios, characters, and situations caused by the game.

While illustrative and presently preferred embodiment(s) of the invention have been described in detail hereinabove, it is to be understood that the inventive concepts may be otherwise variously embodied and employed and that the appended claims are intended to be construed to include such variations except insofar as limited by the prior art.

1) A computer-implemented method for executing an event-based game on a computer in real-time communication with mobile devices of participants, the participants being physically present at the same location, each mobile device being configured to receive instructions from the computer, the method comprising:
the computer executing the game events by communicating the participant-specific instructions to the mobile device associated to the participant;
the participant executing the received instructions;
using an evaluation method of the participants to determine the one or more winners of the game based on feedback received from the mobile device.

2) The computer implemented method of claim 1, where the evaluation method is voting for or against another participant using the mobile device of the participant.

3) The computer-implemented method of claim 1, the instructions received by the mobile device further comprising at least one of the followings:
questions to the participant;
questions with a single or multiple selection of one or more words, letters, numbers, images or sounds;
requesting to draw on the mobile device;
requesting to move the mobile device;
requesting taking a picture, an image or a movement with a camera of the mobile device;
requesting to touch or to select static or moving image on the mobile device;
exchanging virtual goods with other participants;
exchanging virtual goods with the computer;
using virtual tools on the mobile device.

4) The computer-implement method of claim 1, where the evaluation method of the participants further comprising processing the feedback communicated by the mobile device by executing at least one of the followings:
calculating the coherence level of the feedback;
compiling the number of the correct and incorrect feedback;
compiling and comparing number of votes for participants;
compiling a number of trades between participants;
compiling and comparing the value of trades between participants;
compiling number of success or failed to accomplish the instructions communicated by the computer and evaluated by the participants;
compiling number of success or failed instructions accomplished in a participant's challenge evaluated by the participants;
compiling and comparing ranking of the instructions evaluated by the participants;
compiling and comparing ranking of a participant challenge evaluated by the participants;
measuring time reaction between participants;
measuring the time between a question is communicated and the related answer is received by the computer;
measuring time and the precision of a single or sequential execution with the mobile device; or
measuring precision of a movement or an execution with the mobile device.

5) The computer-implement method of the claim 1, wherein the method further comprises automatically selecting a scenario for a thematic game by:
calculating adherence level of each participant based on:
preferences profile of each participant;
appreciation of the participant; and
participation in scenarios and/or characters previously played by each participant;
selecting scenarios and/or characters from a list of available scenarios and/or characters based on the adherence level.

6) The computer-implement method of claim 1, where the method further comprising adding side stories or challenges during execution of a scenario of the game.

7) A computer implementation method according to claim 6, wherein the addition of the side stories or challenges is automatic and wherein the added side stories or challenges are assigned to one or more participants by at least one of the followings:
calculating a predictability index of each participant based on the feedback provided by each participant in the evaluation method and based on activities recorded by one or more sensors of the mobile device of at least one of the participants;
identifying side stories or challenges not yet added to a scenario previously played by at least one of the participants;
matching the side stories or challenges to at least one of the participants based on preferences and aptitudes of each of the at least one of the participants.

8) The computer-implement method of claim 6, where the automatic selection of the side stories or challenges are assigned to the participants based on time and accuracy of the provided feedback from at least one of the participants.

9) The computer implemented method of claim 1, the method further comprising substituting at least one of the participants during game play, wherein the substituted participants are virtual participants controlled by a computer to allow the game to continue without interruption.

10) The computer implemented method of claim 1, the method further comprises adding or substituting participants during game play by:
generating an invitation with a unique identifier associated with the invitation;
communicating the unique identifier to a desired substitute participant;
the desired substitute participant confirming registration by inputting the unique identifier in the mobile device of the participant;
upon reception of the confirmation, adding the substitute participant to the list of participants.

11) The computer implemented method of claim 1, wherein the method further comprises adding at least one participant by a game organizer prior to starting the game play by:
communicating to a game server the coordinates of the mobile device of at least one available participant;
displaying the available participants on a computerized device of the game organizer located within a predetermined radius of the game location;
the game organizer selecting at least one of the available participants to be invited to the game.

12) The computer implemented method of claim 1, wherein the game is a thematic game, the method further comprising:
assigning a character to each participant;
displaying the character information about the character assigned the mobile device associated with the character.

13) The computer implemented method of claim 12, the thematic game being an investigation game, a survival or power rising thematic game, wherein the method further comprises one of the followings:
providing a triggering event;
the participants using the mobile devices to:
exchange information and titles; or
create and reverting alliances;
voting for or against other participants;
computing the game score by calculating or evaluating the performance of the participants through an evaluation mechanism.

14) The computer-implemented method of claim 1, the method further comprising revealing clues or information by transforming an object or a person in a photo taken by a camera of a computerized device, the transformation being displayed on a display unit of the computerized device.

15) The computer implemented method of claim 1, wherein the method further comprises assigning one or more diversion tools to a participant, the one or more diversion tools allowing in any one of the following actions:
altering normal operation of the mobile device of one or more other participants;
sending a request to the mobile device of the one or more other participants for the one or more other participants to perform an action;
imposing a beneficial or punitive action to the one or more other participants.

16) A computer implemented method for managing an event-base game at a physical location using computerized devices of participants, the method comprising:
a game organizer creating an event-based game;
generating an invitation and a unique identifier associated with an invitation;
communicating the unique identifier to a desired participant;
the desired participant confirming registration by inputting the unique identifier in the computerized device;
the game organizer receiving on a computerized device the list of confirmed participants;
the game organizer confirming registration of the registered participants.

17) The computer implemented method of claim 16, the method further comprising communicating data and rules of the game to each computerized device of the participants prior to beginning of the game.

18) The computer implemented method of claim 16, wherein the assignment of a character, a role or a function to each participant prior to the beginning of the game further comprises:
fetching preferences of each participant;
calculating a matching index for each available character based on characteristics of the available character and the fetched preferences of each participant;
assigning to the participant the character, the role or the function having the highest matching index.

19) The computer implemented method of claim 16, the event-based game being public and available, the method further comprising:
a computerized device of an available participant communicating to a game server the coordinates of the computerized device of the available participant;
displaying on a computerized device of the organizing user the available participants located within a predetermined radius of the physical location;
the organizing user selecting one or more available participants to be invited to the thematic game;
the game server communicating the invitation to the selected available participants.

20) The computer implemented method of any claim 16, the method further comprising:
a computerized device of an available participant communicating to a game server the coordinates of the computerized device of an available participant;
displaying on the computerized device of the available participant the created event-based games within a predetermined radius of the computerized device of the available participant;
the available participant registering to one of the displayed event-based games.

21) A system for executing an event-based game for a plurality of participants being at a physical, each participant having a computerized device, the system comprising:
a server comprising:
a processing unit;
a computer program executing a game server on the processing unit;
a storage unit adapted to store:
participant profiles:
a plurality of available games;
the server being configured to:
execute the game events by communicating the participant-specific instructions to the computerized device associated to the participant;
executing an evaluation method of the participants to determine the one or more winners of the game based on feedback received from the mobile device;
calculating score of the game based on the executed evaluation method;
a computerized device of a game organizer in network communication with the server, the computerized device being configured to:
fetch and display the available games from the server;
to select a game to play from the list of available games;
to request to the server to generate and communicate an invitation to the participants, the invitation comprising at a date, a time and the coordinates of the physical location;
send a confirmation of registration of the participants to the game to play;
each computerized device being configured to be in real-time network communication with the server, the computerized device comprising:
a processing unit configured to execute a computer program, the computer program being configured to:
receive the generated invitation;
receive in real time the participant-specific instructions to be executed during the game;
input votes for or against other participants and communicate the inputted votes to the server;
calculating performance of the participant during the game;
a display unit adapted to display game user interfaces, the user interfaces being configured to:
display the invitation;
display the received instructions:
display in real time the scoring calculated by the server.
